(19) United States
(12) Patent Application Publication
(10) Pub. No.: US 2023/0292785 A1
(43) Pub. Date: Sep. 21, 2023

(54) FROZEN FOOD PRODUCT SYSTEMS AND METHODS

(71) Applicant: Frozen Innovations, LLC, Lake Forest, IL (US)

(72) Inventors: Joseph Collins, Lake Forest, IL (US); Yuri Gallegos, Plainfield, IL (US)

(73) Assignee: Frozen Innovations, LLC, Lake Forest, IL (US)

(21) Appl. No.: 18/017,380

(22) PCT Filed: Jul. 22, 2021
(86) PCT No.: PCT/US2021/042857

§ 371 Date: Jan. 20, 2023

Related U.S. Application Data
(60) Provisional application No. 63/055,323, filed on Jul. 22, 2020.
(60) Provisional application No. 63/055,856, filed on Jul. 23, 2020.
(60) Provisional application No. 63/070,814, filed on Aug. 26, 2020.

(51) Int. Cl. A23G 9/12; A23G 9/22; B01F 27/213; B01F 27/09

(52) U.S. Cl. CPC A23G 9/12; A23G 9/224; B01F 27/213; B01F 27/09; B01F 2101/13

(57) ABSTRACT

A frozen food appliance and related method of making a frozen food product. A rotational drive assembly configured in an axial alignment using a direct drive to produce rotational movement of a blade element to contact a frozen food precursor in a frozen food container associated with the frozen food appliance where the rotational drive assembly omits rotational speed modifying gears and transmissions positioned between a drive motor and the blade element. In another aspect, a rotational drive assembly may be kept in axial alignment with a frozen food container via a multi portioned container mount having a float connector.

### RELATED APPLICATION DATA

This application claims the benefit of priority of U.S. Provisional Patent Application Ser. No. 63/055,323, filed Jul. 22, 2020, and titled “Frozen Food Product Systems and Methods;” U.S. Provisional Patent Application Ser. No. 63/055,856, filed Jul. 23, 2020, and titled “Frozen Food Product Systems and Methods;” and U.S. Provisional Patent Application Ser. No. 63/070,814, filed Aug. 26, 2020, and titled “Frozen Food Product Systems and Methods,” each of which is incorporated by reference herein in its entirety.

### DETAILED DESCRIPTION

The current disclosure includes systems and methods related to frozen food products, devices and methods for preparing frozen food products, frozen food product precursors, and related systems and methods.

Frozen food products, such as ice cream, sorbetto, sorbet, gelato, milk shakes, and the like, have a variety of textures and features that are highly desirable to human tastes.

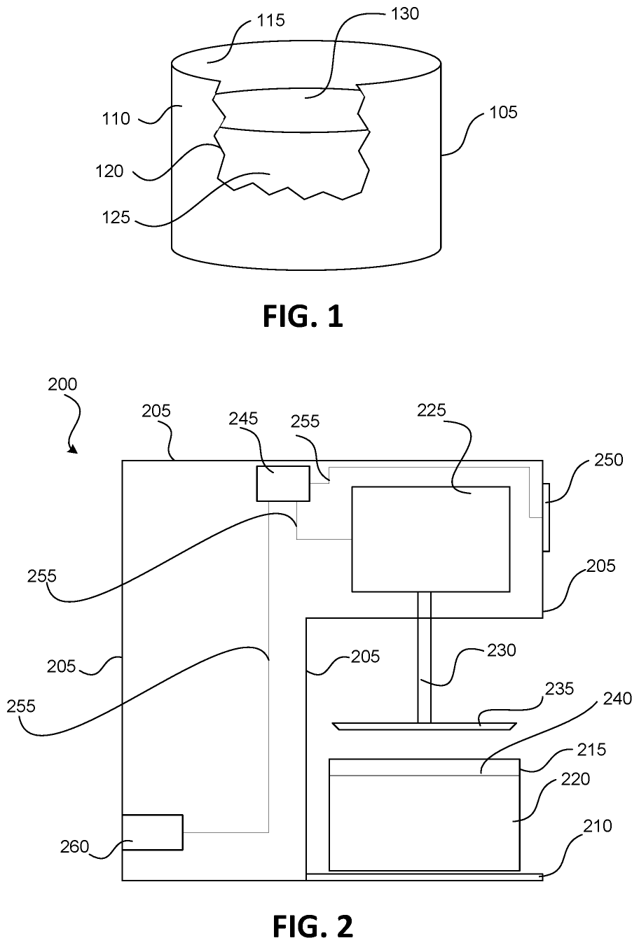

FIG. 1 illustrates a frozen food container 105 having an outside surface 110 and an inside surface 115. The wall of container 105 is shown with cutaway 120 revealing a frozen food precursor 125 inside container 105. Food precursor 125 has an upper surface 130. Frozen food container 105 is shown as a cylindrical container. Other shapes for a frozen food container are contemplated. Examples of alternative shapes include, but are not limited to a conical cylinder, a rectangular container, a square container, and an elliptical cylinder container. The container walls of container 105 are shown as perpendicular to the bottom of the container. It is contemplated that container walls may be pitched at an angle and/or include features (e.g., ripples, indents, hand grips, waves) and/or have an internal dimension that is not consistent from the top to the bottom of the container. Container 105 may be made of any material consistent with the current disclosure. Considerations for selection of a material for a frozen food container according to the current disclosure include, but are not limited to, ability of the material to be frozen (e.g., to a temperature low enough to freeze a frozen food precursor such as precursor 125), ability of the material to be unfrozen (e.g., to a temperature high enough to unfreeze a frozen food precursor such as precursor 125), strength of the material to withstand mechanical processing according to one or more of the aspects disclosed herein for processing of a frozen food product and/or precursor, ability of the material to be shipped from a manufacturing and/or distribution location to a customer location via a commercially available shipping service (e.g., with a precursor frozen, refrigerated, or at ambient temperature form inside); and any combinations thereof. Example materials for a frozen food container, such as container 105, include, but are not limited to, a metal (e.g., aluminum, tin, steel, stainless steel), a plastic (e.g., PTFE), and a paper (e.g., a cold temperature capable cardboard).

Container 105 can have a cover (not shown) for covering the opening in the upper side of container 105 (e.g., during storage, during shipment). A variety of possible covering types and materials are contemplated. Example cover materials include, but are not limited to, a foil material, a material that is the same as that of the remainder of the container, a material that is different from that of the remainder of the container, a metal, a plastic, a paper round cutout, and any combinations thereof. A cover may attach to a frozen food container (such as container 105) in any of a variety of ways. Example attachment types for a cover include, but are not limited to, a pressure-fit, an adhesive fit, a screw attachment, a keyed notch attachment, peel away attachment, shrink-fit plastic, and any combinations thereof. In one exemplary aspect, a cover for a frozen food container may be removable in part or in whole prior to processing using a frozen food appliance of the current disclosure.

Container 105 is shown having precursor 125 filled to a given level. A frozen food container according to the current disclosure can be filled with a frozen food precursor to any desired level. In one exemplary aspect, a frozen food container may have little to no frozen food precursor or resultant frozen food concoction (also referred to as a frozen food product) therein (e.g., upon consumption by a user, prior to filling with a frozen food precursor, etc.).

Frozen food precursor 125 is a mixture of food ingredients (e.g., mixture of fat, sugar, protein, and/or water) that upon freezing followed by mechanical processing with a frozen food appliance as set forth herein becomes a desired frozen food concoction. Example frozen food concoctions include, but are not limited to, ice cream, sorbet, sorbetto, gelato, soft-ice, ice milk, frozen shake drink, milk shake, ice coffee, and any combinations thereof. A frozen food precursor is formulated to be frozen and then processed mechanically by a device of the current disclosure. The step of freezing the frozen food precursor in the container may occur before and/or after the container is shipped to the end customer. In one example, a precursor is frozen in a container before shipment and maintained in a frozen state (e.g., with packaged dry ice) until it arrives at a customer location. In another example, a precursor is kept at a chilled temperature during shipment to a customer location. Example ingredients for a precursor include, but are not limited to, a fat, a sugar, a protein, water, a flavoring agent, a fruit, a vegetable, a nut, a syrup, a caramel, a candy (e.g., chocolate, hard candy, chewing gum, etc.), a cookie, a stabilizer agent, an emulsifier agent, and any combinations thereof. In one example, a precursor includes a milk fat, a sugar, and water.

In one exemplary aspect, a container (e.g., container 105) with a frozen food precursor therein is shipped to an end user who can utilize a frozen food appliance of the current disclosure to process the precursor into an end product frozen food. The end user may choose to store the container in their household freezer for later processing. At the time of processing, the cover of the container is removed and the top surface of the precursor is brought into contact with a blade element of a frozen food appliance of the current disclosure. A variety of mechanisms and/or methods of bringing the blade element of an appliance into contact with a surface of a precursor are contemplated and a variety of alternatives will be apparent in light of the current disclosure. Examples of a mechanism and/or method of bringing a blade element of an appliance of the current disclosure into contact with a surface of a frozen food precursor include, but are not limited to, placing a frozen food container in a stationary position on or in a frozen food appliance and moving the blade element with respect to the frozen food container through an opening in the frozen food container to contact a precursor, placing a frozen food container in a container holder and positioning the container holder to allow a moving blade element to come into contact with a precursor in the frozen food container (e.g., through an opening in the frozen food container and the container holder), attaching a frozen food container and/or corresponding container holder to a container mount of a frozen food appliance, shielding a blade element from a user via a shielding element (e.g., a shroud, locking collar, or other shielding that protects a path of a blade element as it moves into contact with a precursor in a frozen food container), and any combinations thereof.

The blade element is rotated at a predetermined speed and is slowly advanced through the frozen precursor such that tiny amounts of the precursor are removed from the surface at a time and subjected to an agitation that causes a gas to be incorporated into the mixture. This process is repeated as the blade element advances through the frozen precursor to a desired level. The speed of rotation of the blade element and the speed of advance into the frozen precursor may vary depending on the precursor and the desired end result product. In one example, rotation of a blade element is at a speed about 1,000 revolutions per minute (rpm) to about 4,000 rpm. In another example, rotation of a blade element is at a speed of about 2,000 rpm to about 3,000 rpm. In another example, rotation of a blade element is at a speed of about 2,500 rpm to about 3,500 rpm. In still another example, rotation of a blade element is at a speed of about 3,000 rpm. In yet another example, rotation of a blade element is at a speed of about 2,000 rpm. The speed of rotation of a blade element may change throughout the advance of the blade element leading up to contact with the surface of frozen precursor, through a frozen precursor, and then as withdrawn from the surface of the frozen precursor back through the now processed resultant frozen food product. The mechanism of contact of a blade element with a surface of frozen precursor may include any of a variety of interactions depending on aspects such as the blade element configuration, speeds, temperature of the frozen precursor, and/or precursor material makeup. Example interactions include, but are not limited to, melting via contact with a portion of a blade element a small increment of the surface of frozen precursor, shaving via contact with a portion of a blade element a small portion of the surface of frozen precursor, aerating the shaved and/or melted precursor material, whipping the shaved and/or melted precursor material, and any combinations thereof.

In one exemplary aspect, prior to processing an end user may add one or more additional ingredients to a precursor. Example additional ingredients include, but are not limited to, a flavoring, a fruit, a vegetable, a nut, a syrup, a caramel, a candy (e.g., chocolate, hard candy, chewing gum, etc.), a cookie, and any combinations thereof. An additional ingredient may be pre-processed (e.g., made into chunks/pieces, ground, crushed, pureed, blended, etc.) prior to addition. In one exemplary aspect, a precursor mixture may be such that addition of additional ingredients are extraneous to the precursor's ability to form a desired frozen food product by the mechanical processing with an appliance of the current disclosure (i.e., such additional ingredients are not necessary, but only a desirable addition). Addition of additional ingredients may require the precursor to be allowed to thaw sufficiently to mix in the additional ingredients and subsequently refrozen before processing. In another example, additional ingredients are added prior to freezing precursor.

Once processed, the resultant frozen food product may be eaten and/or stored for later consumption (e.g., directly using the container itself or another container).

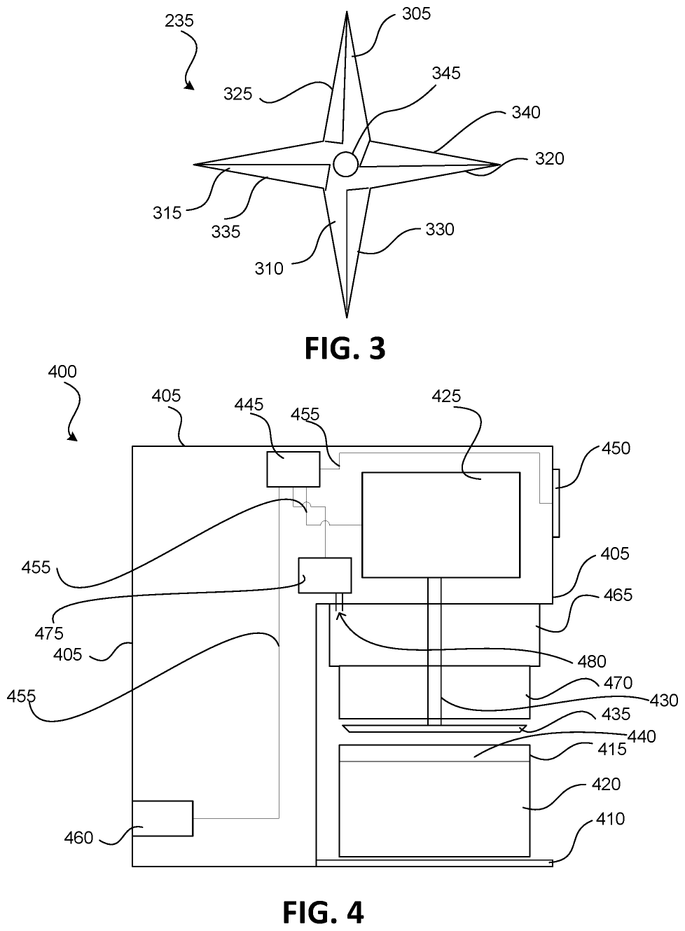

Aspects of a frozen food appliance are illustrated in the exemplary embodiment of a frozen food processing appliance 200 in FIG. 2. Appliance 200 is shown as a cross-sectional block diagram with a housing 205 and a base 210. Base 210 is configured to have a frozen food container 215 with a frozen food precursor 220 therein positioned on base 210. Such configuration may include shape and features (not shown) that match the desired container 215 to assist in alignment and/or retention of container 215. Appliance 200 includes a drive mechanism 225 connected to a shaft 230. A blade element 235 is connected to shaft 230. Appliance 200 is shown with a configuration in which frozen food container 215 is positioned on base 210 in a stationary fashion with an axial alignment of an opening in the top of frozen food container 215, drive mechanism 225, shaft 230, and blade element 235 where blade element 235 in operation moves vertically along the axial alignment into the opening of container 215 to come into contact with an upper surface 240 of precursor 220. As discussed above and as is apparent from the multiple examples provided herein, other variations of the interrelationship of a frozen food container with a frozen food appliance of the current disclosure are possible.

Drive mechanism 225 includes one or more motors (e.g., a DC motor, an AC motor) and one or more gears or other supporting elements configured to provide rotational and axial downward movements to shaft 230 in a manner in which the rate and degree of advance are controlled to move blade element 235 with respect to an upper surface 240 of precursor 220 to provide the desired processing. In an automated embodiment of a frozen food appliance, a drive mechanism (such as drive mechanism 225) may include a rotational drive mechanism and an axial movement drive mechanism. A rotational drive mechanism includes components and configuration that allow a blade element to rotate with respect to a precursor in a frozen food container. Rotational drive components may act in relationship with other components, such as a drive shaft (such as drive shaft 230), a blade element (such as blade element 235), appropriate connectors, and optionally other components to form a rotational drive assembly. Examples of components of a rotational drive assembly include, but are not limited to a motor (a direct drive motor, a direct current “DC” motor, etc.), a drive shaft, connector elements, a magnet, a gear, a transmission, a blade element, and any combinations thereof. An axial movement drive mechanism includes components and configuration that allow for a blade element to move axially (e.g., upward and downward with respect to a precursor in a frozen food container). Examples of such components include, but are not limited to a motor (e.g., a stepper motor), a linear actuator (e.g., ball screw), a staging or other connector component connected to a rotational drive apparatus (e.g., via a mounting bracket connected to a motor of a rotational drive apparatus and a linear actuator of an axial movement drive apparatus), connector elements, and any combinations thereof. In one exemplary aspect, an embodiment of the current disclosure may include a rotational drive apparatus that includes a motor and a drive shaft connected to a blade element (along with appropriate connector elements) without the use of a gear or a transmission between the motor and the blade element such that the motor directly drives (via the shaft and appropriate connectors) the blade element (e.g., at a predetermined rotational speed when not in contact with precursor and another different rotational speed when in contact with precursor). In one example of such a rotational drive apparatus, a motor, a drive shaft, and a blade element are in an axial alignment with each other (e.g., as shown in a vertical axial alignment in appliance 200). In another such example, a frozen food container when connected to a frozen food apparatus is maintained in axial alignment with a rotational drive apparatus even when an intended starting axial alignment of all or a component of the rotational drive apparatus is changed (e.g., through damage to the appliance, vibrational movement, etc.) with respect to the appliance itself. Details of this latter example are discussed further below.

Returning again to FIG. 2, in one example, drive mechanism 225 includes a motor (e.g., a DC motor) for driving the rotational movement of shaft 230 and a stepper motor and linear stage coupled to a ball screw (driven by the stepper motor) for driving the downward and upward axial movement of shaft 230. In one example, a stepper motor allows precise incrementing of vertical movement of a blade element in small increments while controlling distance traveled. One alternative example for providing vertical movement as part of an axial movement drive apparatus includes the use of a DC motor with limit switches to control vertical travel distance. Various stepper motors are known by those of ordinary skill that could be selected and configured based on the teachings herein. In one example, a stepper motor may be a model KR-20 type motor manufactured by THK America, Inc. of Schaumburg, Ill.

Appliance 200 includes a control circuitry 245 for controlling components of appliance 200, including controlling the components of drive mechanism 225 to provide a desired rotation and axial advance (and retraction) of blade 235 via shaft 230. Control circuitry 245 may include any necessary circuits and components for controlling a frozen food appliance and its features. Example components of a control circuitry include, but are not limited to, a processor, a memory, an electrical connection, a circuit board, a control bus, a video driving circuitry, and any combinations thereof Various examples and embodiments are described herein and illustrated with various drawings in which components (e.g., a user interface, an audio component, a motor, a power supply, etc.) are shown without connections to corresponding control circuitry. It will be apparent from the disclosure that there are various mechanisms in the art (e.g., electrical wiring connecting a component to a control circuitry) to provide operable connection of a component to control circuitry to perform functionality and methods described herein.

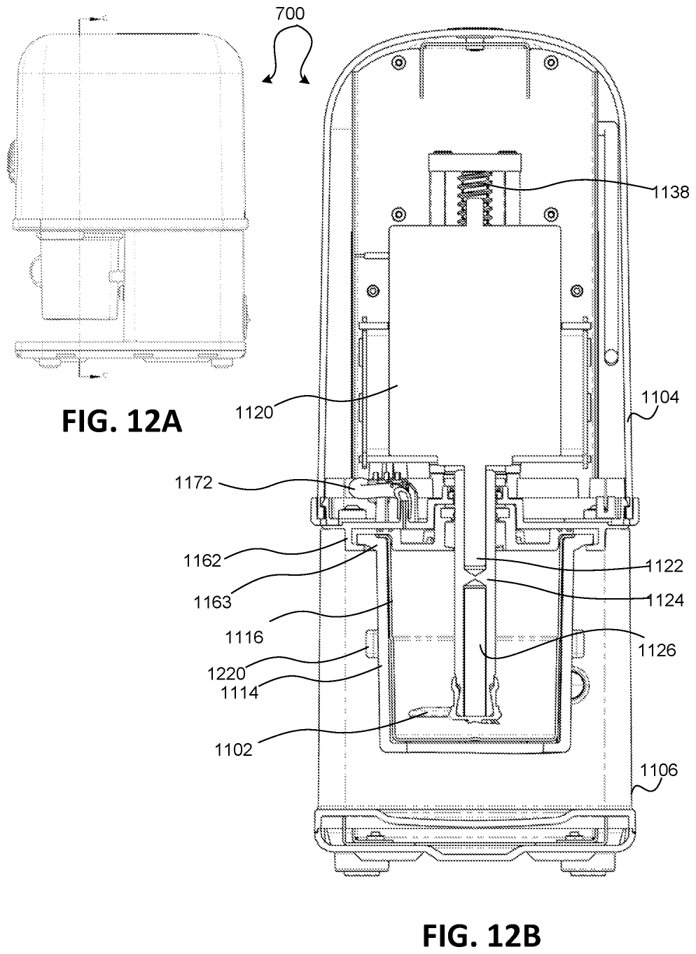

Appliance 200 includes a user interface 250 for allowing an end user of appliance 200 to input and/or receive output information from appliance 200. User interface 250 may include multiple interfaces and/or be disbursed such that one or more elements of user interface 250 are included on a connected device (e.g., on a user computing device connected to appliance 200 via a network). An example of a remote user interface is discussed with respect to FIG. 10. Example user interfaces include, but are not limited to, a button, a switch, an indicator light, a display device (e.g., an LCD, LED, or other display device), a touch sensitive input (e.g., a touchscreen), a toggle, a dial, an audio input (e.g., a microphone), an audio output (e.g., a speaker, headphone jack, etc.), an optical sensor, a motion sensor, a connection to a communications network (e.g., a telecommunications and/or data network), Bluetooth communications circuitry, and any combinations thereof. In one example, a frozen food appliance includes a button for actuating the appliance on and off and/or selecting a program that advances a blade element through a precursor to a desired location. User interface 250 is shown connected via internal electrical connections 255 to control circuitry 245. Any one or more components of appliance 200 may be connected via internal electrical connections 255. Appliance 200 includes a power supply 260 connected to other components of appliance 200 via internal electrical connections 255 for supplying electrical power. Electrical connections 255 may include variety of connections including, but not limited to, a data connection, an analog actuation connection, a power connection, and any combinations thereof. Example power supplies include, but are not limited to, a connection to household power (e.g., via a corded connection), a capacitor, a battery (e.g., a fixed batter, a removable battery, etc.), an inductive connection to an external power source, a switching power supply (e.g., a 24 VDC, 400 watt switching power supply such as one manufactured by Mean Well USA, Inc. of Fremont, California or AmpFlow brand sold by Powerhouse Engineering, Inc. of Belmont, California), and any combinations thereof.

Blade element 235 may be removably connected to shaft 230. One of skill will recognize a variety of ways to removably connect a blade element to a shaft. Examples of a mechanism for removable connection of a blade element to a shaft include, but are not limited to, a screw connection, a snap connection, a magnetic connection, an angled gear, a bayonet connection, and any combinations thereof.

In one exemplary operation, appliance 200 may be actuated by an end user via user interface 250 to begin a mechanical processing of precursor 220. Upon actuation, control circuitry 245 controls drive mechanism 225 to provide rotation to blade element 235 and to provide axial movement of blade 235 downward toward upper surface 240. As blade element 235 is slowly advanced downward, blade element 235 contacts precursor 220. The contact causes small portions of precursor to be separated from the frozen surface 240. The removed portions of precursor are aerated (i.e., a gas such as air is incorporated into the material) by the blade element to form the desired end product frozen food. Blade element 235 advances slowly downward into precursor 220 thus upper surface 240 changes to be located further downward in conjunction with the downward advance of blade element 235 and the removed precursor and end product are above moving upper surface 240. Once blade element 235 has progressed axially downward to the predetermined degree, control circuitry 245 controls drive mechanism 225 to stop axial advance and move shaft 230 and blade element 235 upward out of the resultant frozen food product and container 215 such that container 215 may be removed from appliance 220. In one example, blade element 235 continues rotational movement (e.g., at the same or different speed) as it moves upwardly out of container 215.

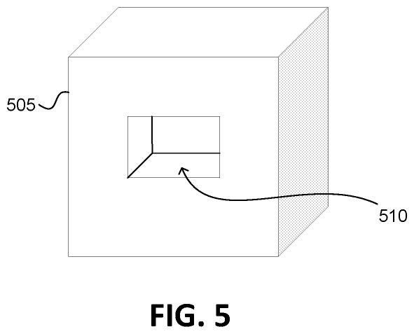

Any blade element configuration capable of removing desired small portions of frozen precursor and aerating the removed precursor may be utilized. A blade element may include one or more blades. In one example, a blade element includes one or more blades designed to contact the surface of a precursor to remove portions of the precursor as it advances through precursor. In another example, a blade element includes one or more blades offset from a point of contact with a surface of a precursor (e.g., positioned upwardly from contact blades on the blade element as the blade element is mounted to a shaft of a frozen food appliance) such that the one or more blades do not contact the surface but move through removed precursor above the surface of the frozen precursor as the blade element rotates. In yet another example, a blade element includes (a) one or more blades designed to contact the surface of a precursor to remove portions of the precursor as it advances through precursor and (b) one or more blades offset from a point of contact with a surface of a precursor (e.g., positioned upwardly from contact blades on the blade element as the blade element is mounted to a shaft of a frozen food appliance) such that the one or more blades do not contact the surface but move through removed precursor above the surface of the frozen precursor as the blade element rotates. Blade element 235 is shown in a top view in FIG. 3. In FIG. 3 blade element 235 is shown including two blades 305, 310 positioned opposite each other and two blades 315, 320 positioned opposite each other. Blades 305, 310 are configured with leading edges 325, 330 designed to contact a surface of a frozen precursor at an angle to provide a desired penetration into the surface and to remove a desired portion (e.g., via melting, shaving, etc.) of precursor from the frozen surface. Blades 315, 320 are configured with leading edges 335, 340 that are positioned offset in a position that when blade element 235 is mounted to shaft 230, edges 335, 340 are located upward vertically from edges 325, 330 such that edges 325, 330 contact surface 240 and edges 335, 340 rotate above surface 240 without contacting surface 240. Blade element 235 includes connector 345 for removable connection to shaft 230.

Blade element 234 is shown having a radius slightly smaller than the radius of container 215. Other radial sizes may be utilized depending on the desired outcome. In one example, a blade element has a radius slightly smaller than the smallest radius of the container in which it shall be utilized. An appliance may be configured to receive (e.g., via removably connectable blade elements) multiple different sized blade elements sized and configured for different sized and configured containers.

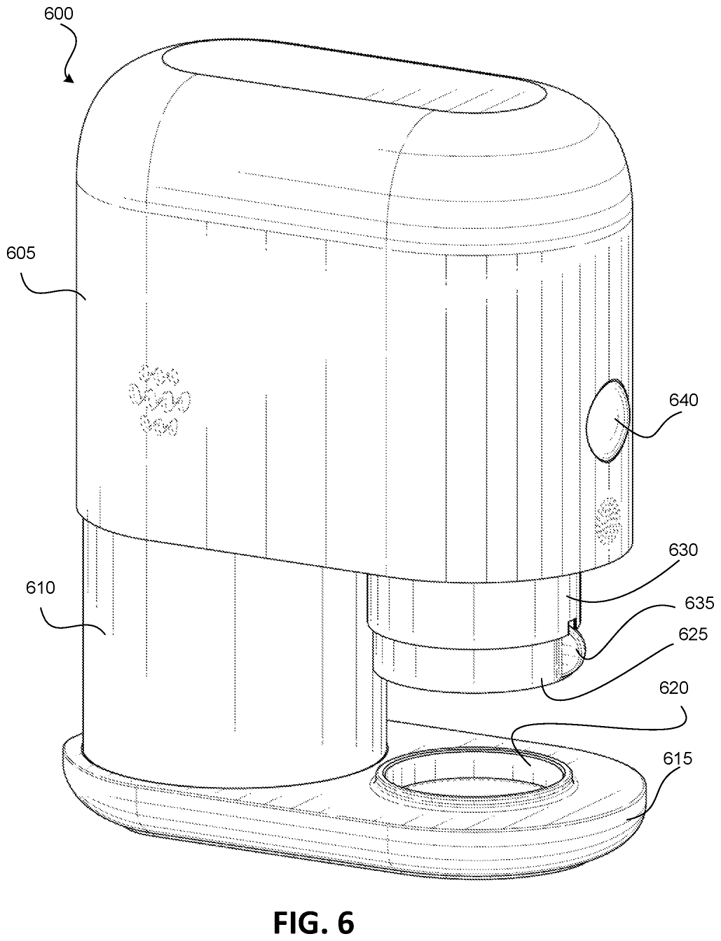

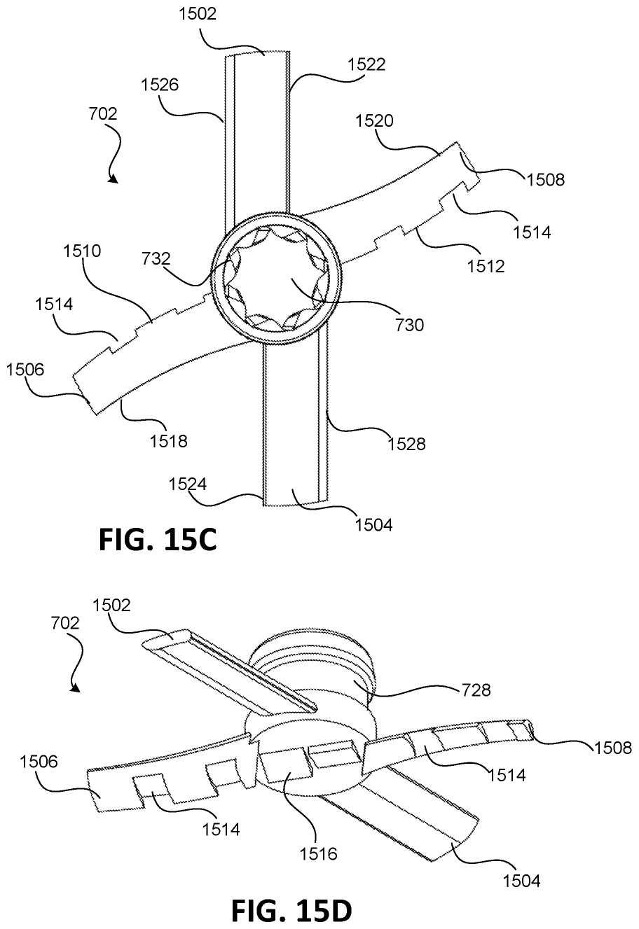

Other blade configurations are contemplated (e.g., blade configuration shown in FIGS. 15A to 15D). For example, various blade configurations and related aspects are disclosed in U.S. Pat. No. 4,547,076 to Maurer entitled “Method and Apparatus for Making Soft-Ice in Small Quantities,” (the “'076 patent”) the content of which is hereby incorporated herein by reference in its entirety. In FIGS. 4 to 11 of the '076 patent is disclosed an example blade/agitator configuration, such blade configuration and supporting disclosure of movement through a frozen material is incorporated herein by reference for use in an appliance such as appliance 200.

Appliance 200 is shown with blade 235 and shaft 230 openly exposed when not inserted in container 215. A frozen food appliance (such as appliance 200) may optionally include a locking collar. A locking collar is a mechanism for (a) enclosing the portion of a drive shaft that is outside of the housing and blade element when outside of a frozen food container and (b) connecting to the opening of a frozen food container. In one exemplary aspect, enclosing a blade element provides a level of safety (e.g., shielding blades from human contact). In another exemplary aspect, connecting to the opening of a frozen food container provides a level of containment to separated precursor and resulting end product frozen food during processing. An example of a locking collar is discussed below with respect to FIG. 4.

A frozen food appliance (such as appliance 200) may optionally include a pump device configured to insert a gas into the volume above the surface of a precursor in a frozen food container. Any of various pump devices may be utilized to accomplish the insertion of gas to a particular configuration of an appliance as set forth herein. In one example, a pump device includes a diaphragm pump device (e.g., a model YW02-DC12 diaphragm pump device sold by Changzhou Yuanwang Fluid Technology Co., Ltd (ywfluid.com) of Jiangsu Province, China). In one exemplary aspect, insertion of a gas (e.g., at higher than atmospheric pressure) may provide a benefit of causing more aeration of the gas into the removed precursor such that the end product frozen food includes a fluffier and/or airier consistency. A mechanism for providing a gas seal to contain pumped in gas may also be provided. In one example, a pump in combination with a locking collar can be configured to provide a gas tight seal to allow a gas to be pumped into the volume above a surface of a precursor. Example gases for pumping above the surface of a precursor include, but are not limited to, oxygen, air, nitrogen, carbon dioxide, and any combinations thereof. An example of a pump device is discussed below with respect to FIG. 4.

A frozen food appliance (such as appliance 200) may optionally include a network interface device. A network interface device includes circuitry and components that allow the appliance to communicatively connect to a remote device over a network (e.g., controlled via a control circuitry such as circuitry 245). Various network interface devices are well known including, but not limited to, a network interface card (e.g., a mobile network interface card, a local area network card), a modem, a wireless radio circuitry (e.g., Bluetooth, near field communication radio, WiFi, mobile network, etc.) and any combinations thereof. Example remote devices include, but are not limited to, another household appliance, a computing device (e.g., a computer workstation, a terminal computer, a server computer, a handheld device (e.g., a tablet computer, a personal digital assistant “PDA”, a mobile telephone, a smartphone, a smart wearable device such as a watch), a web appliance, a network router, a switch, a bridge, any machine capable of executing a sequence of instructions that specify an action to be taken by a machine), and any combinations thereof. Example networks include, but are not limited to, a direct connection to another device, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), and any combinations thereof. A network may employ a wired and/or a wireless mode of communication. In general, any network topology may be used. In one example, a network interface may allow an appliance to connect to a remote device to allow the remote device to include one or more portions of a user interface to the appliance. Other exemplary benefits and features of a network interface are discussed below with respect to FIG. 10.

A frozen food appliance (such as appliance 200) may optionally include a container reader and/or writer device. A container reader and/or writer device is a component and/or circuitry (and related controller executable instructions) capable of detecting a container identifier module included with a frozen food container and reading information included in or associated with the container identifier module and/or writing information to the container identification module. A container identifier module is a device and/or feature that stores information about the frozen food container, the precursor in a frozen food container, an end product frozen food producible from a precursor in a frozen food container, and/or related information. This information may include actual information and/or an identifier that can be utilized to retrieve actual information from a remote location (e.g., over a network using a network connection). Example container identifier modules include, but are not limited to, an RFID circuit, an optically readable imprint (e.g., a UPC code, a QR code, etc.), an optically readable storage medium, a magnetically readable storage medium, and any combinations thereof. A corresponding container reader and/or writer device will be configured to read and/or write to the type of container identifier utilized on desired containers. For example, if containers for use with an appliance include an RFID storage circuit, a corresponding appliance may include an RFID reading and/or writing circuitry configured and positioned proximate to the location of a connected container to read the signal from the RFID storage circuit included with the container. For optical readable imprints and media, an optical reader (e.g., a camera) may be included with an appliance. For magnetically readable media, a magnetic medium reader may be included with an appliance. Information that may be stored on a container identifier module and/or in a remote storage location include, but are not limited to, information about the enclosed precursor and/or resultant end product (e.g., flavor, ingredients, date of manufacture, date of expiry), allergy information, directions for processing (e.g., speed of rotation, speed of axial advance of blade element), recipes for using a resultant frozen food product, a unique identifier for the container (e.g., an identifier that is not duplicated for other containers in production), an identifier for the container that is not unique to the container (e.g., an identifier that is unique to a flavor, ingredient, brand, etc.) and any combinations thereof. In examples where information is stored remotely related to a container, one or more elements of information read from a container identifier module may be utilized to retrieve remotely stored information. Additionally, one or more elements of information may be stored in a memory element of the appliance and retrieved from the memory element based on information retrieved from a container identifier module. In one exemplary aspect, information obtained locally and/or remotely regarding a particular container may be utilized by an appliance to confirm that the container is a container known to be compatible with the appliance. Such a confirmation may be a safety concern in that in certain exemplary appliances blade element rotation and movement may create a risk to an end user (e.g., rapidly rotating blade element contacting a side wall of a container) if utilized with a non-compatible (e.g., shape, configuration, material, strength, etc.) container.

FIG. 4 illustrates another example of a frozen food appliance 400 for processing a frozen food product. Components of appliance 400 that are similar to those of appliance 200 may have the same features and functions discussed with respect to those components unless specifically stated otherwise. Additionally, any of the options, alternatives, features, and functions described herein with respect to other examples and embodiments may be combined or used in the alternative with those of frozen food appliance 400 where appropriate. Appliance 400 includes a housing 405 and a base 410. Base 410 is configured to have a container 415 placed thereon. Container 415 is shown with a frozen food precursor 420 therein having an upper surface 440. Appliance 425 includes a drive mechanism 425 connected to a shaft 430 for rotating shaft 430 and moving shaft 430 axially in a downward/upward direction. Blade element 435 is removably connected to shaft 430. Appliance 400 includes a control circuitry 445, a user interface 450, internal connections 455, and a power supply 460.

Appliance 400 includes a locking collar having an upper portion 465 and a lower portion 470. Locking collar portion 470 is movably connected to the inside of locking collar portion 470 such that portion 470 telescopes in and out of portion 465. Locking collar portion 470 is configured to move downward to connect (e.g., key and slot connection, pressure connection, screw connection, a bayonet connect, etc.) to the top open portion of container 415 (e.g., by connection to the top of the outer walls of container 415). In one example, this connection of container 415 to portion 470 creates a gas tight seal creating a volume inside the locking collar and above surface 440 of precursor 420. Blade 435 is configured to move axially in a vertical direction with respect to surface 440 inside the locking collar mechanism. A sensor (not shown) can be included to indicate that a locking collar is in a position of contact with a container for example to indicate to a control circuitry that it is safe to begin movement of a blade element.

Appliance 400 may also include a pumping device 475 configured and controllable via control circuitry 445 to pump a gas (e.g., from a connected gas chamber not shown, from ambient air, etc.) via pump outlet 480 into a volume within the locking collar mechanism and above surface 440. This gas may be pumped into this volume at a pressure higher than ambient air pressure in the proximity of the appliance. In one example, an amount of air is pumped into the volume above surface 440 that is 1 bar above ambient atmosphere. In an exemplary aspect, extra gas pressure above surface 440 may result in a frozen food product after processing with blade element 435 that includes more gas incorporated into the resultant product than would have been incorporated without the increased pressure (e.g., producing a fluffier product). An optional gas pressure sensor may be included as a separate component and/or as part of pump 475 to determine if a pressure in the volume above surface 440 is at a desired pressure (e.g., and to indicate a stop command to pump 475).

Appliance 200 is shown with an open configuration for blade travel into an opening of a frozen food container and appliance 400 is shown using a shielded connector (locking collar 465/475) to connect a frozen food container to appliance 400 (e.g., in axial alignment with rotational drive components). A frozen food appliance of the current disclosure may include a container mount that includes appropriate components and configuration to allow the connection of a frozen food container to the frozen food appliance in alignment with a corresponding blade element. A container mount may be part of and/or connected to a housing and/or structural components thereof. Example components for a container mount include, but are not limited to, a container connector component, a container seal component for providing a seal between a connected frozen food container and a container mount, a shaft seal component for providing a seal between a drive shaft (e.g., of a rotational drive apparatus) and a container mount, an opening to allow a drive shaft to be positioned through a container mount (e.g., a drive shaft connected to a motor within a housing at one end on one side of the opening and connected to a blade element on the other side of the opening), a connection between the container mount and a rotational drive apparatus (e.g., via a seal element encompassing a drive shaft of the rotational drive apparatus and connected to a portion of the container mount while allowing the drive shaft to rotate within the seal), one or more safety circuits (e.g., a safety switch for shutting off a motor when a frozen food container is not properly connected), one or more connectors for a pumping device for pumping a gas into a volume of a connected frozen food container, and any combinations thereof. A container connector component includes such structure and configuration to allow the fixed connection of a frozen food container to a container mount and/or frozen food appliance. For example, a container mount may include a structural element configured to mate with a structural component of a corresponding frozen food container. Examples of connection components for connecting a frozen food container include, but are not limited to, a surface that allows for a pressure connection, a key and slot connector, a screw connector, a bayonet connector, a sealing element, a shielding element (e.g., a shroud, locking collar, etc.), and any combinations thereof. A container mount may include multiple portions that are allowed to move with respect to each other (e.g., a first portion that connects to a rotational drive assembly and a second portion that connects to a housing and/or structural component of the frozen food apparatus such that the first portion may move a certain amount in a predetermined direction with respect to the second portion). More details of such an example are discussed further below.

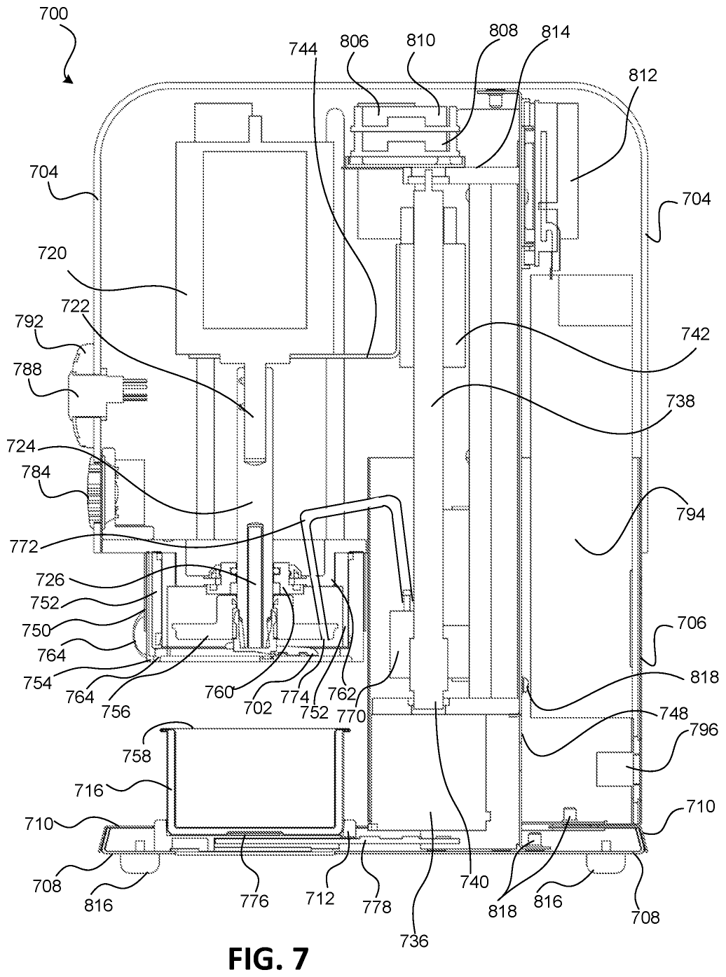

Appliances 200, 400 are shown with a certain cross sectional form factor. Other form factors can be employed that allow a blade element to come into contact with a surface of a frozen precursor in a container in a controlled manner rotationally and axially. One exemplary form factor is illustrated in FIG. 5 as a rectangular cubic housing 505 with a compartment opening 510 to receive a container. With a container disposed in opening 510, a blade element may be controlled to descend into the container as set forth herein. Modification of the components of an appliance as disclosed herein to fit within different form factors such as that shown in FIG. 5 will be understandable to those of ordinary skill from the current disclosure. Housings of an appliance as set forth herein may be shaped and sized in any fashion to enclose necessary internal components of the appliance and to provide requisite movement of a blade element in relation to positioning of a container including frozen food precursor. A housing may include necessary structural components (e.g., framing, brackets, connectors, inner and/or outer wall structures, etc.) Example materials for a housing and/or a housing structural component include, but are not limited to, a plastic, a metal (e.g., aluminum, steel, stainless steel, etc.), a glass, and any combinations thereof.

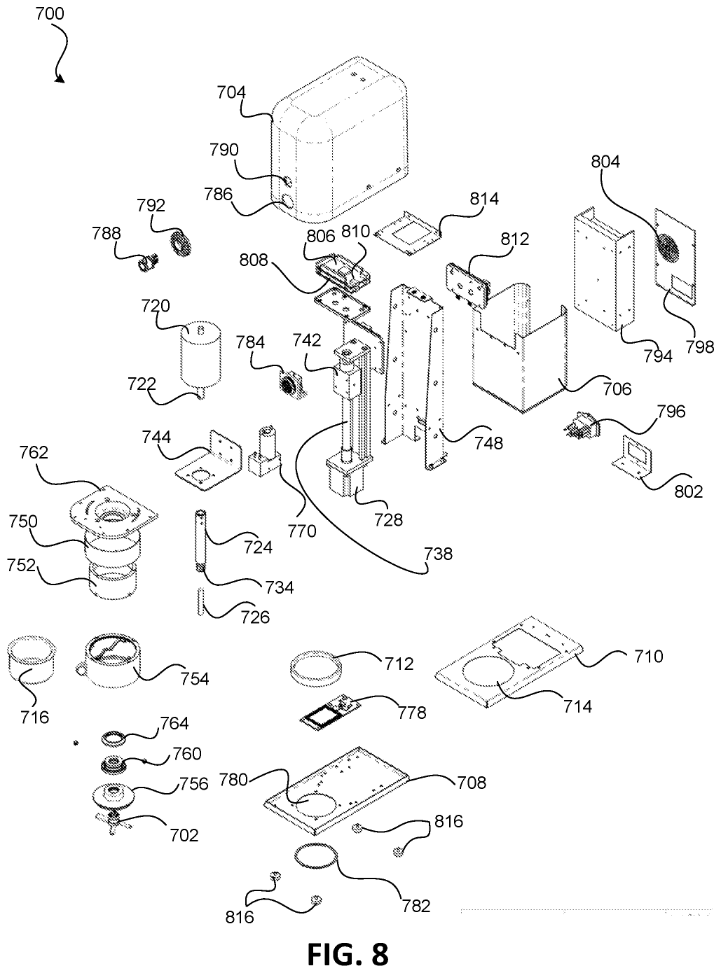

FIG. 6 illustrates a perspective outer view of an exemplary frozen food appliance 600. Appliance 600 may include any combination of components (and the disclosed interrelationships) discussed herein for processing a frozen food precursor to a frozen food product as set forth herein and such components may include any combination of the features and functions discussed herein for such components unless expressly stated. Appliance 600 includes an upper housing portion 605, a lower housing portion 610, and a base 615. Base 615 includes features 620 configured to position and/or retain frozen food container (not shown) in relation to a locking collar mechanism having a lower collar portion 625 telescopically connected to an upper collar portion 630. Lower collar portion 625 includes a tab 635 for a user to grasp to move lower collar portion 625 with respect to upper collar portion 630 and a container in order to connect lower collar portion 625 to an upper opening in the container (e.g., forming a gas-tight seal and creating a volume above a surface of the precursor in the container in which to, for example, pump a pressure of a gas). Appliance 600 also includes a button user interface 640 to allow a user of the appliance to actuate operation to have a blade element (not shown) contact a surface of a precursor in a container.

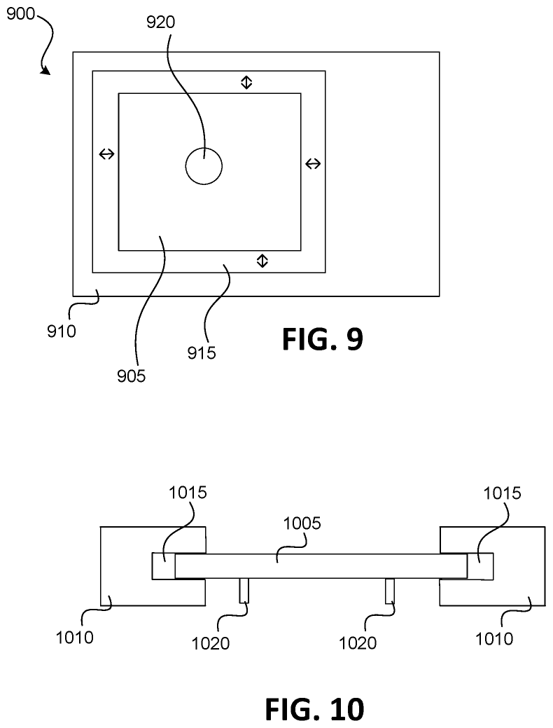

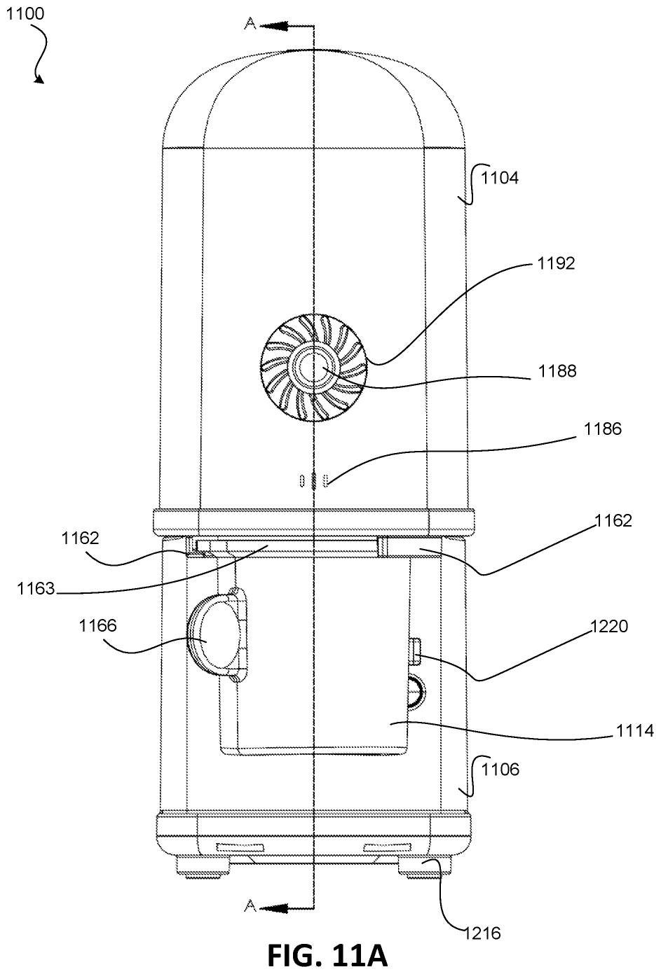

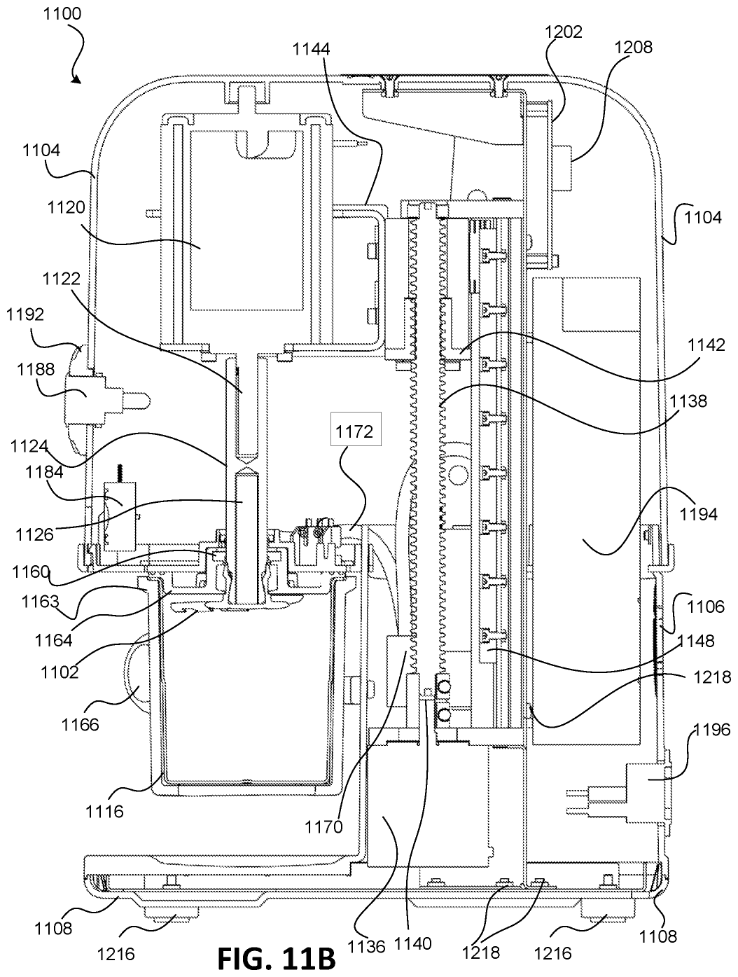

FIG. 7 illustrates a section view of an interior of another exemplary frozen food appliance 700. FIG. 8 illustrates an exploded view showing various parts of appliance 700. FIGS. 9A, 9B, 9C, 9D illustrate an exemplary blade element 702 that may be utilized with an appliance of the current disclosure, such as appliance 700. With reference to FIGS. 7, 8, 9A, 9B, 9C, 9D an exemplary embodiment of a frozen food appliance according the current disclosure is explained. It is noted that the individual components, features, aspects, and functionalities of this embodiment can, as appropriate under the circumstances, be utilized alone and in any subcombination with other components, features, aspects, and/or functionalities of this embodiment and with any other embodiment or implementation such as those discussed above with respect to Appliances 200, 400, 600. Additionally, components of appliance 700 may share features, aspects, and functionalities of similar components of other embodiments, such as appliances 200, 400, 600 and elsewhere as described in the current disclosure unless expressly stated otherwise.

Appliance 700 is illustrated in FIG. 7 as having blade element 702 removably attached to appliance 700 as an exemplary implementation. It is noted that other types of blade elements may also be utilized with appliance 700. Appliance 700 includes an upper housing portion 704 and a lower housing portion 706. A base of appliance 700 includes a lower base portion 708, a base cover 710, and a container holder feature 712. Container holder feature 712 connects within opening 714 in base cover 710 and is configured to assist in placement and/or retention of a frozen food container, such as frozen food container 716 shown positioned on the base of appliance 700 in FIG. 7 partially seated within an inner circumference of container holder feature 712. In one or more alternative implementations, a frozen food appliance may include a container holder that encompasses a frozen food container further than done by container holder feature 712. In one exemplary aspect, a container holder may be a structure into which a frozen food container may be placed prior to connection with a frozen food appliance. A container holder may include one or more container connectors that are shaped and configured to mate with corresponding container connectors of a container mount and/or appliance housing. In one example, a container holder includes the appropriate container connectors for connection in place of having the frozen food container make such a connection. A container holder may include structure (such as extension tabs, pressure connectors, etc.) for limiting the movement (e.g., rotational movement, vertical movement, lateral movement) of a frozen food container placed therein. Such structure may be made to match with structure of the frozen food container to aid in the limitation of movement. A container holder may include container connectors that are positioned, sized, and configured to connect to container connectors on a frozen food connector positioned therein.

Appliance 700 includes a drive mechanism that includes DC (direct current) motor 720 configured to provide a rotation via an extension 722 extending downwardly from the bottom of motor 720. Various DC motors are known to those of ordinary skill that can be configured to perform as described herein in a frozen food appliance such as those set forth herein. In one example, a DC motor is a high amperage DC motor (e.g., a high amperage DC motor of model E30-150 from AmpFlow brand sold by Powerhouse Engineering, Inc. of Belmont, California). Extension 722 is connected to a shaft 724 which includes an internal recess in which a cylindrical magnet 726 is positioned. A shaft, such as shaft 724 for connecting a drive mechanism to a blade element of an appliance may include one or more materials such as, for example, a metal (e.g., aluminum, steel, stainless steel), a magnetic metal, an alloy, a polymer, a plastic, and any combinations thereof. In one example, shaft 724 is made of a material that includes a magnetic material (e.g., magnetic stainless steel) such that magnet 726 magnetically adheres to shaft 724 with sufficient attraction that magnet 726 does not succumb to gravity and displace from shaft 724. Other forms of connection of magnet 726 to shaft 724 (e.g., if shaft 724 is made of a material that does not include sufficient magnetic material for adhesion) are contemplated. Examples of a connection for a magnet include, but are not limited to, an adhesive, a magnetic connection, a physical connector (e.g., a pin, a screw, etc.), a snap connection, an angled gear connection (e.g., an angled gear that is configured to self-support with the rotation of a shaft), and any combinations thereof. Blade element 702 is connected to a lower end of shaft 724. Blade element 702 includes a mounting portion 728 that includes a recess 730 therein that includes a set of slots and ridges 732 forming a “female” connector. Shaft 724 includes a set of slots and ridges 734 located at its lower end forming a “male” connector. Slots and ridges 734 of shaft 724 are shaped, sized, and configured to match that of slots and ridges 732 of blade element 702 such that slots and ridges 734 fit inside mounting portion 728. It is contemplated that certain variations on shape, size, and configuration of slots and ridges, as well as different lock and key variations on slots and ridges may exist. In one exemplary aspect, such a lock and key fit between a shaft and a blade element allow the blade element to receive rotational force from the shaft with little or no slippage. In this embodiment, blade element 702 includes a magnetic material in its composition (e.g., magnetic stainless steel) that is sufficient to connect blade element 702 to shaft 724 to a degree that blade element 702 does not fall off during operation, but that blade element 702 can be removed from shaft 724 using end user manual force.

The drive mechanism of appliance 700 also includes a stepper motor 736 connected to a lead screw 738 at a terminal end 740. A slide block 742 is configured with lead screw 738 to move vertically within appliance 700 driven by stepper motor 736. A motor mounting plate 744 is attached to slide block 742 and to DC motor 722. As stepper motor 736 operates to move slide block 742 in a vertical direction (e.g., downwardly or upwardly), that motion is translated to DC motor 720, shaft 724, and blade element 702 which are free to move vertically within upper housing 704. This allows blade element 702 to move downward into container 716 to a surface of a frozen precursor (not shown) to mechanically process the precursor to a frozen food product as described herein.

Lead screw 738 is connected to a vertical support structure 748. Vertical support structure 748 is connected to lower base portion 708 and extends upwardly through lower housing portion 706 and upper housing portion 704.

Appliance 700 includes a locking collar mechanism that includes a collar cover 750, an upper collar shroud 752 that is fixed in position within cover 750 (optionally, extending downward from cover 750), and a lower collar shroud 754 that is rotatably connected to collar cover 750 and/or upper collar shroud 752 such that as lower collar shroud 754 is rotated lower collar shroud 754 moves downwardly to a position that allows contact of container 716 with a container seal 756 connected inside a volume within cover 750. Container seal 756 is shaped, sized, and configured to match the circumference of an upper opening 758 in container 716 such that when contact is made with the upper end of sidewalls of container 716 a seal (e.g., a gas-tight seal) is created. Such a seal prevents a gas from escaping from the volume in container 716 above a surface of a precursor (not shown) and below container seal 756. Blade element 702 moves within this sealed volume. A shaft seal 760 provides a seal in an opening of structural divider 762 of upper housing 704. An appliance of the current disclosure may include a safety mechanism to indicate to control circuitry that a collar is sufficiently lowered to provide a shield from the movement of the blade element of the appliance during operation. Such a signal can allow the control circuitry to prevent operation of the blade element if the collar shroud is not in a predetermined position (e.g., contacting a frozen food container, such as contacting to a container seal) sufficient to provide end user protection from the blade element. Appliance 700 includes a safety switch 764 that is located proximate the lower opening of lower collar shroud 754. Safety switch 764 includes structural components and/or electronic circuitry configured to detect that lower collar shroud 754 has been moved to a position that provides contact of container 716 with container seal 756. In one example, safety switch 764 is configured to send appropriate electrical signals to control circuitry of appliance 700 to allow such control circuitry to control the drive mechanism of appliance 700 such that when lower collar shroud 754 is not lowered to a predetermined safe position, the drive mechanism will not rotate and/or lower blade element 702.

Lower collar shroud 754 includes a tab 766 to provide a surface for actuation of lower collar shroud 754 by an end user. Appliance 700 includes a gas pump 770 and connective tubing 772 connected to an pump output of gas pump 770 and terminating at terminal opening 774. Terminal opening 774 is configured to allow a gas pumped by gas pump 770 to be directed into the volume that is created above an upper surface of a precursor in container 716 when container 716 is contacted with container seal 756. In one example, gas pump 770 is an air pump configured to access ambient air and to pump it into the volume above a frozen upper surface of a precursor in container 716 during operation when container 716 is contacting container seal 756. Such air is added at a desired pressure to effectuate a certain result of aeration by blade element 702 as discussed herein. In one example, a desired pressure may be controlled by control circuitry of appliance 700 (e.g., set by an end user using a user interface, set by a manufacturer, informed by information read from a container identification module, etc.).

Container 716 includes a container identification module 776 (e.g., in the form of an RFID module) and appliance 700 includes a container reader and/or writer device 778 (e.g., in the form of an RFID reader and writer circuitry). Container identification module 776 is positioned on and/or in the bottom wall of container 716. Container reader and/or writer device 778 is located in lower base portion 708 proximate a location where container 716 is positioned and includes appropriate circuitry to read and/or write to container identification module 776. Lower base portion 708 includes an opening 780 and an opening cover 782. In this example, upper base cover 710 includes opening 714 which may assist in communication between container reader and/or writer device 778 and container identification module 776.

Appliance 700 includes an audio speaker 784 that is exposed to the outside of upper housing 704 through an opening 786. A user interface 788 in the form of a user actuatable push button is located on the outside of upper housing 704 with internal connection through opening 790. A spacer 792 is located proximate user interface 788.

Appliance 700 includes a power supply 794 for powering components of appliance 700 and a power supply switch 796. Power supply 794 is connected to and configured to be turned on/off by power supply switch 796 which is mounted to an opening in a housing plate 798 using mounting bracket 802. A vented opening 804 is provided in housing plate 798 to provide ventilation to power supply 794. A radio communication circuit 806 (e.g., Bluetooth wireless radio) is included to provide communication between appliance 700 and one or more remote devices (e.g., a cloud resource, a user computing device).

Mechanical and electrical components of appliance 700 (e.g., DC motor 720, stepper motor 728, container reader and/or writer device 778, pump 770, speaker 784, button 788, radio circuit 806) are controlled by appropriate control circuitry of appliance 700. Appliance 700 includes a processor 808 and appropriate machine-executable instructions (e.g., in the form of software, such as firmware, stored in one or more memory elements associated with processor 808, stored in the cloud, etc.) to be executed by processor 808 to control the components of appliance 700 and/or perform methodologies described herein. Appliance 700 includes additional control circuitry to work in conjunction with processor 808 and/or independently (along with appropriate machine-executable functions) to perform one or more functions and/or controls: a stepper driver circuit 810, a spin DC motor controller 812. Processor 808, radio circuit 806, stepper driver circuit 810 are connected to vertical support structure 748 via bracket 814 (e.g., on one or more circuit boards).

Appliance 700 includes feet 816. Physical interconnection of components in appliance 700 may be effectuated by one or more of a variety of well-known connector mechanisms (e.g., a rivet, a screw, a pin, a pressure fit, etc.). Some such interconnector elements 818 are shown in FIG. 7. Electrical and power connection between and amongst components as appropriate include corresponding electrical and/or power connectors (e.g., a wire) that are not shown but will be understood by those of ordinary skill.

Certain of the examples above have shown a platform-type base on which a container is positioned such that a blade element moves downwardly into the container and, optionally a locking collar moves downward to interface with the container. Alternative mechanisms may include mechanisms for moving the container upwardly (e.g., a manually or electronically moveable platform, a manually attachable receptacle for the container, etc.). In exemplary implementations, such upward movement of the container may be in combination with a locking collar, be usable to close the distance between the axially moving blade element and the container, bring the container into a connection with a housing that provides a seal (e.g., an air tight seal, a safety protective seal) with the container, and any combinations thereof. In one example, an appliance may include a separate holding vessel (e.g., a container holder) shaped and configured to receive a frozen food container as described herein. The holding vessel may include a connector (e.g., a pressure connector, a key/slot connector, a screw connector, a snap on connector, etc.) configured to mate to a corresponding connector of a housing of an assembly that positions the container (in the vessel) such that it is aligned with a blade element of the appliance (and, optionally, creates a gas-tight seal for examples with a gas pump component).

It is possible that a frozen food appliance according to this disclosure may be subjected to one or more forces that impacts the positioning of the axial alignment of a blade element with a frozen food container. Such forces may result from shipping incidents, impacts with other objects (such as in a dropping incident), vibrations, and/or other forces. Other reasons may exist for misalignment prior to, after, and/or during use. Negative consequences of such a misalignment include, but are not limited to, a blade element coming into contact with an interior side wall of a frozen food container, seizing of a drive mechanism, and any combinations thereof. In one exemplary aspect, one or more embodiments as described herein may include a container mount that includes appropriate components and configuration to allow the connection of a frozen food container to the frozen food appliance in alignment with a corresponding blade element and that allows for the frozen food container to remain in substantial alignment with the rotational drive shaft axis of alignment even if the drive shaft axial alignment deviates with respect to the position of the frozen food apparatus housing and/or structural elements. Generally, substantial alignment with the rotational drive shaft axis is such an alignment retention to prevent the corresponding blade element from striking an inside wall of the frozen food container during operation. In one example, substantial alignment provides for deviation in alignment between the rotational drive shaft axis and the center alignment of the blade element within the walls of the corresponding frozen food container when connected (defined by a center projection of the axis of the rotational drive shaft axis downwardly into a connected container) of less than a predetermined amount (e.g., about a set amount of millimeters). In one such implementation, a frozen food appliance (e.g., appliance 200, 400, 600, 700, 1100) may include a container mount that includes a first portion that connects to a rotational drive assembly (e.g., a rotational drive motor, drive shaft, blade element) and a second portion that connects to a housing and/or structural component of the frozen food apparatus such that the first portion may move a certain amount in a predetermined direction with respect to the second portion. A first portion of a container mount may connect to a rotational drive assembly in a variety of ways. Examples of connection components for connecting a container mount portion to a rotational drive assembly include, but are not limited to, a seal. A first portion also includes one or more frozen food container connectors shaped, selected, sized, and otherwise configured to allow a frozen food connector to mate/connect thereto and the first portion includes an opening that allows a corresponding rotational drive shaft to be positioned therein. In such a configuration, the end of the drive shaft connected to the rotational drive motor is positioned on one side of the opening in the first portion and the end of the drive shaft connected to a blade element (and the blade element) are positioned on the other side of the opening in the first portion. The first portion and the second portion are connected to each other using a floating connector mechanism. A floating connector mechanism is such that movement of the first portion is allowed with respect to the second portion over a range of motion between the two portions in one or more directions. In one example, a container mount is positioned such that its longest dimension is intersecting (e.g., perpendicular or close to perpendicular to) the axis formed by the length dimension of a rotational drive shaft of the frozen food apparatus (i.e., the axial alignment axis). In such an example, a first portion and the corresponding floating connector may be configured to allow movement with respect to the second portion in a direction close to the longest dimension. Example floating connector components include, but are not limited to, a flange screw connection between a first portion and a second portion in which one or more flange screws are inserted in holes in one of the first portion and the second portion that have a diameter larger than the diameter of the flange screw and the flange screw fixedly connects to screw holes in the other portion allowing movement to the degree of the difference in the size of the flange hole and the flange screw; a seated connection wherein one of a first portion and a second portion are seated within a conformal ridge of the other portion that restricts movement in one or more directions while allowing movement between the portions over a desired range of motion in one or more other directions; other connector types; and any appropriate combinations thereof. A type of floating connection may be included in a container mount of any of the embodiments herein as an alternative to provide additional functionality.

FIGS. 9 and 10 illustrate one exemplary implementation of a floating connection between a first and second portion of a container mount. FIG. 9 includes a top-down view of a container mount 900 that includes a first portion 905 and a second portion 910. First portion 905 is positioned in an opening in second portion 910 and connected via a floating connection such that first portion 905 is capable of movement across a range of motion 915 (in the directions of the arrows) with respect to second portion 920. Any floating connection may be included between first portion 905 and second portion 910. In one example second portion 910 is a part of a housing of a frozen food appliance and/or part of a structural component of the housing. First portion 905 includes an opening 920 through which a rotational drive shaft may be positioned. First portion 905 is connected to a corresponding rotational drive shaft in a manner to allow rotational movement within opening 920 (e.g., via a shaft seal) but wherein lateral movement within opening 920 is limited such that first portion 905 moves laterally with lateral movement in the axial alignment of the drive shaft.

FIG. 10 illustrates a cross section of an exemplary implementation of a floating connection between a first portion 1005 of a container mount and a second portion 1010 of a container mount. First portion 1005 is shown seated within a ridge or valley 1015 in second portion 1010 such that space exists to allow first portion 1005 to move laterally within the ridge/valley 1015. In this example, vertical movement of first portion 1005 within ridge/valley 1015 is limited spatially. First portion 1005 is shown with container connectors 1020 for connecting to a frozen food container.

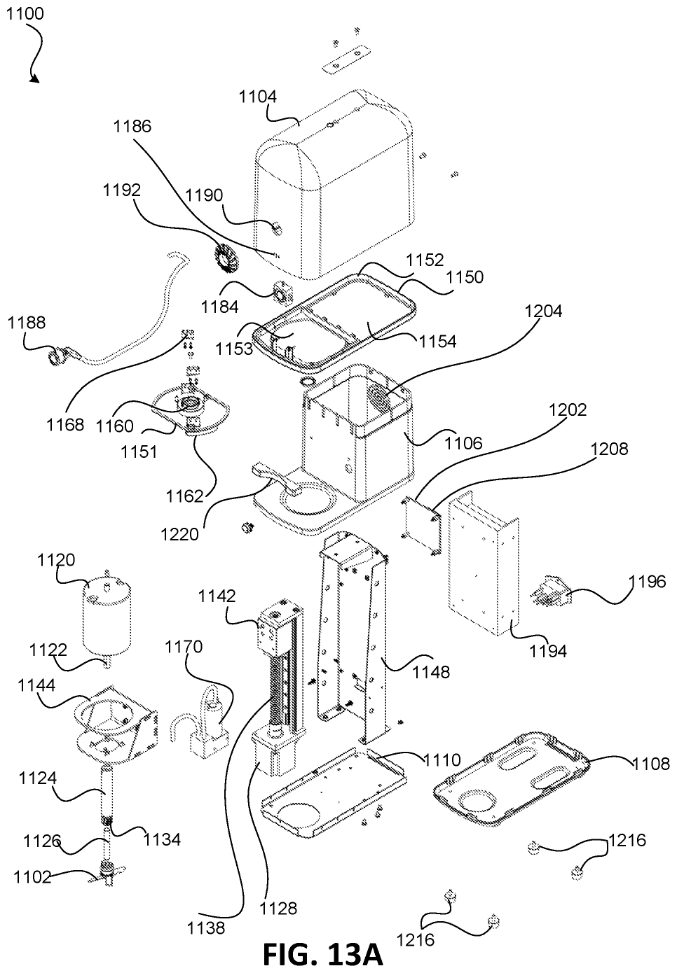

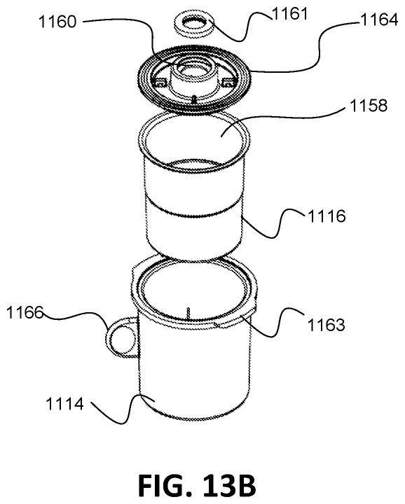

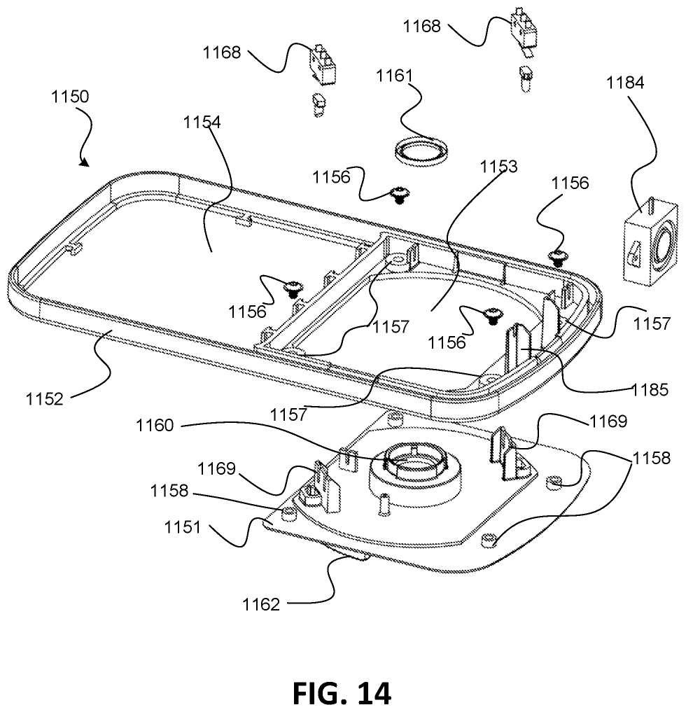

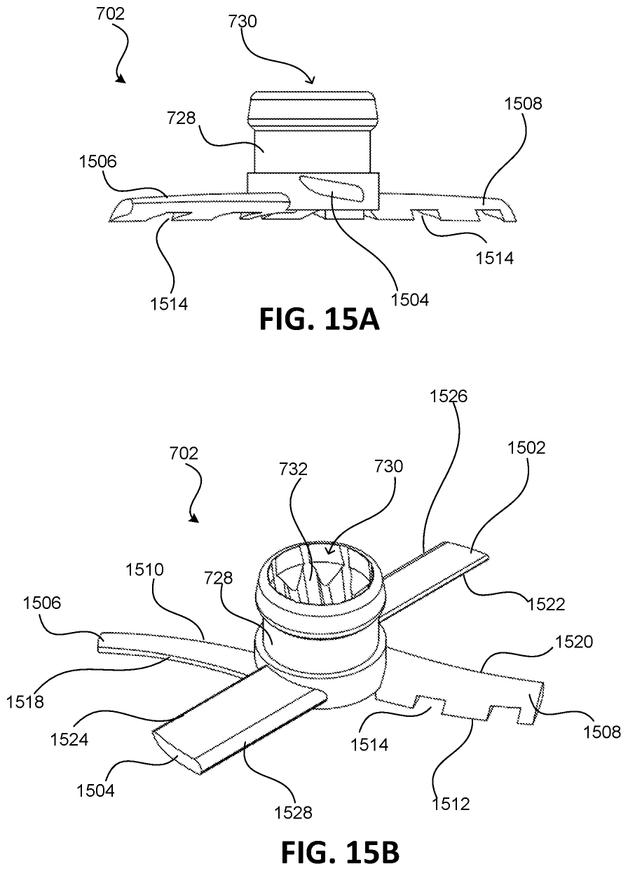

FIG. 11A illustrates a front side view of yet another exemplary frozen food appliance 1100. FIG. 11A shows a cross section line “A” and FIG. 11B illustrates a section view of an interior of appliance 1100 along line “A.” FIG. 12A illustrates a side view of appliance 1100 showing a cross section line “C” and FIG. 12B illustrates a section view of an interior of appliance 1100 along line “C.” FIGS. 13A and 13B illustrate an exploded view showing various parts of appliance 1100. FIG. 14 illustrates a view of an exemplary container mount having a first portion, a second portion, and a floating connector. With reference to FIGS. 11A, 11B, 12A, 12B, 13A, 13B, 14 an exemplary embodiment of a frozen food appliance according to the current disclosure is explained. It is noted that the individual components, features, aspects, and functionalities of this embodiment can, as appropriate under the circumstances, be utilized alone and in any subcombination with other components, features, aspects, and/or functionalities of this embodiment and with any other embodiment or implementation such as those discussed above with respect to Appliances 200, 400, 600, 700. Additionally, components of appliance 1100 may share features, aspects, and functionalities of similar components of other embodiments, such as appliances 200, 400, 600, 700 and elsewhere as described in the current disclosure unless expressly stated otherwise.

Appliance 1100 is illustrated in FIG. 11 as having blade element 1102 removably attached to appliance 1100 as an exemplary implementation. It is noted that other types of blade elements may also be utilized with appliance 1100. Appliance 1100 includes an upper housing portion 1104 and a lower housing portion 1106. A base of appliance 1100 includes a lower base portion 1108 and an internal base plate 1110. Lower housing portion 1106 covers over plate 1110 and connects to lower base portion 1108. A container holder 1114 is shown with a frozen food container 1116 positioned therein. In this example, frozen food container 1116 is a cylindrical shaped container having an upper opening 1158 and container holder 1114 is also a cylindrical shaped container of larger volume than frozen food container 1116 such that frozen food container 1116 conformally fits therein.

Appliance 1100 includes a drive mechanism that includes a motor 1120 (e.g., a direct current “DC” motor) that includes an extension 1122 extending downwardly from the bottom of motor 1120. Extension 1122 is connected to a shaft 1124 which includes an internal recess in which a cylindrical magnet 1126 is positioned. Blade element 1102 is connected to a lower end of shaft 1124. Blade element 1102 includes a mounting portion 1128 that includes a recess 1130 therein that includes a set of slots and ridges 1132 forming a “female” connector. Shaft 1124 includes a set of slots and ridges 1134 located at its lower end forming a “male” connector. Slots and ridges 1134 of shaft 1124 are shaped, sized, and configured to match that of slots and ridges 1132 of blade element 1102 such that slots and ridges 1134 fit inside mounting portion 1128. In one exemplary aspect, such a fit between a shaft and a blade element allow the blade element to receive rotational force from the shaft with little or no slippage. In this embodiment, blade element 1102 includes a magnetic material in its composition (e.g., magnetic stainless steel) that is sufficient to connect blade element 1102 to shaft 1124 to a degree that blade element 1102 does not fall off during operation, but that blade element 1102 can be removed from shaft 1124 using end user manual force. Motor 1120, shaft 1124, and blade element 1102 are connected in axial alignment along an axis that is defined by the center axis of shaft 1124 to form an axial rotational drive apparatus. Such axial alignment positions blade element 1102 to be rotated at a desired speed in relation to a frozen food precursor in container 1116.

The drive mechanism of appliance 1100 also includes a stepper motor 1136 connected to a lead screw 1138 at a terminal end 1140. A slide block 1142 is configured with lead screw 1138 to move vertically within appliance 1100 driven by stepper motor 1136. A motor mounting plate 1144 is attached to slide block 1142 and to DC motor 1122. Motor 1120 is connected to mounting plate 1144 and is positioned within a top opening in plate 1144. Extension 1122 and shaft 1124 are positioned through a lower opening in plate 1144. As stepper motor 1136 operates to move slide block 1142 in a vertical direction (e.g., downwardly or upwardly), that motion is translated to DC motor 1120, shaft 1124, and blade element 1102 which are free to move vertically with respect to upper housing 1104. This allows blade element 1102 to move downward into container 1116 to a surface of a frozen precursor (not shown) to mechanically process the precursor to a frozen food product as described herein.

Lead screw 1138 is connected to a vertical support structure 1148. Vertical support structure 1148 is connected to lower base portion 1108 and extends upwardly through lower housing portion 1106 and upper housing portion 1104.

Appliance 1100 includes a container mount 1150 that includes a first portion 1151 and a second portion 1152. In this example container mount 1150 second portion 1152 includes a first opening 1153 configured to receive first portion 1151 and a second opening 1154 configured to match with an opening in lower housing portion 1106 and to allow structures such as vertical support structure 1148 (discussed further below) to be positioned across both upper housing portion 1104 and lower housing portion 1106. Second portion 1152 in this example is positioned between upper housing portion 1104 and lower housing portion 1106. First portion 1151 is connected to second portion 1152 with a floating connector 1155 that includes flange screws 1156 and holes 1157 in first portion 1151 and holes 1158 in second portion 1152. Holes 1157 are configured with a diameter that is larger than the diameter of flange screws 1156. Holes 1158 are configured to fixedly connect to flange screws 1156. This configuration allows first portion 1151 to move laterally within opening 1153 of second portion 1152 by a range of motion that is the differential in diameter between holes 1157 and the diameter of flange screws 1156.

First portion 1151 includes an opening 1160 shaped and configured to include shaft 1124 therein along with a shaft seal element 1161 that connects shaft 1124 to first portion 1151 while allowing shaft 1124 to rotate within opening 1160. First portion also includes a container connector 1162 that is designed and configured to mate with a container connector 1163 of container holder 1114. In this example container connectors 1162 and 1163 are in the form of a twist and lock connector in which container connector 1163 is inserted into container connector 1162, container holder 1114 is twisted to engage the twist/lock mechanism, and container holder 1114 engages frozen food container 1116 with first portion 1151 to form a connection. In one example, a container seal element 1164 is positioned between first portion 1151 and container holder 1114 (e.g., connected to an underside of first portion 1151) to aid in the creation of a connection between frozen food container 1116 and first portion 1151 such that gas transfer between the volume within food container 1116 and the outside air is limited. Container holder 1114 may include a tab 1166 (or other mechanism) to provide a surface to assist an end user in rotating container holder 1114 with respect to container connector 1162.

Appliance 1100 includes a safety switches 1168 that is located as part of first portion 1151 of container mount 1150 and includes structural components and/or electronic circuitry configured to detect (e.g., via electrical contact with a portion of frozen food container 1116 and/or container holder 1114) that frozen food container 1116 and/or container holder 1114 is connected to container mount 1150. In one example, safety switch 1168 is configured to send appropriate electrical signals to control circuitry of appliance 1100 to allow such control circuitry to control the drive mechanism of appliance 1100 such that when proper connection of food container 1116 and/or container holder 1114 is not detected, the drive mechanism will not rotate and/or lower blade element 1102. In this example, safety switches 1168 are connectable to part connectors 1169 of first portion 1151. The inclusion of more than one safety switch may provide a benefit of redundancy.

Appliance 1100 includes a gas pump 1170 and connective tubing 1172 connected to a pump output of gas pump 1170 and terminating such that gas can flow into a volume within frozen food container 1116 (e.g., via an opening in first portion 1151). Such a gas may be directed into the volume that is created above an upper surface of a precursor in container 1116 when container 1116 is contacted with container seal 1164. In one example, gas pump 1170 is an air pump configured to access ambient air and to pump it into the volume above a frozen upper surface of a precursor in container 1116 during operation when container 1116 is contacting container seal 1164. Such air is added at a desired pressure to effectuate a certain result of aeration by blade element 1102 as discussed herein. In one example, a desired pressure may be controlled by control circuitry of appliance 1100 (e.g., set by an end user using a user interface, set by a manufacturer, informed by information read from a container identification module, etc.).

Container 1116 may include an optional container identification module (e.g., in the form of an RFID module) and appliance 1100 may include an optional container reader and/or writer device (e.g., in the form of an RFID reader and writer circuitry).

Appliance 1100 includes an audio speaker 1184 that is exposed to the outside of upper housing 1104 through an opening 1186. Audio speaker 1184 is connectable to a part connector 1185 of first portion 1151. A user interface 1188 in the form of a user actuatable push button is located on the outside of upper housing 1104 with internal connection through opening 1190. A spacer 1192 is located proximate user interface 1188.

Appliance 1100 includes a power supply 1194 for powering components of appliance 1100 and a power supply switch 1196. Power supply 1194 is connected to and configured to be turned on/off by power supply switch 1196 which is mounted to an opening in a housing plate 1198 using mounting bracket 1202. A vented opening 1204 is provided in lower housing portion 1106 to provide ventilation to power supply 1194.

Mechanical and electrical components of appliance 1100 (e.g., DC motor 1120, stepper motor 1128, container reader and/or writer device 1178, pump 1170, speaker 1184, button 1188, radio circuit 1206) are controlled by appropriate control circuitry of appliance 1100. Appliance 1100 includes a control circuitry 1208 and appropriate machine-executable instructions (e.g., in the form of software, such as firmware, stored in one or more memory elements associated with processor 1208, stored in the cloud, etc.) to be executed by control circuitry 1208 to control the components of appliance 1100 and/or perform methodologies described herein. Control circuitry 1208 is mounted to mounting bracket 1202 which is connected to vertical support structure 1148. Control circuitry 1208 may include one or more of a processor, a stepper driver circuit, a spin DC motor controller, a radio communication circuit, one or more circuit boards, and/or other circuitry.

Appliance 1100 includes feet 1216. Physical interconnection of components in appliance 1100 may be effectuated by one or more of a variety of well-known connector mechanisms (e.g., a rivet, a screw, a pin, a pressure fit, etc.). Some such interconnector elements 1218 are shown. Electrical and power connection between and amongst components as appropriate include corresponding electrical and/or power connectors (e.g., a wire) that are not shown but will be understood by those of ordinary skill.

Appliance 1100 includes a container positioning assist element 1220 located on an outer surface of lower housing portion 1106 in a position facing container holder 1114. A container positioning assist element is a structural element that is shaped, configured and positioned to provide structural guidance to the connecting of a container holder and/or a frozen food container with a frozen food appliance, such as appliance 1100. In this example, container positioning assist element 1220 is sized to fill a portion of the space between the outer wall of lower housing portion 1106 and container holder 1114 when container holder 1114 is positioned to connect to appliance 1100.

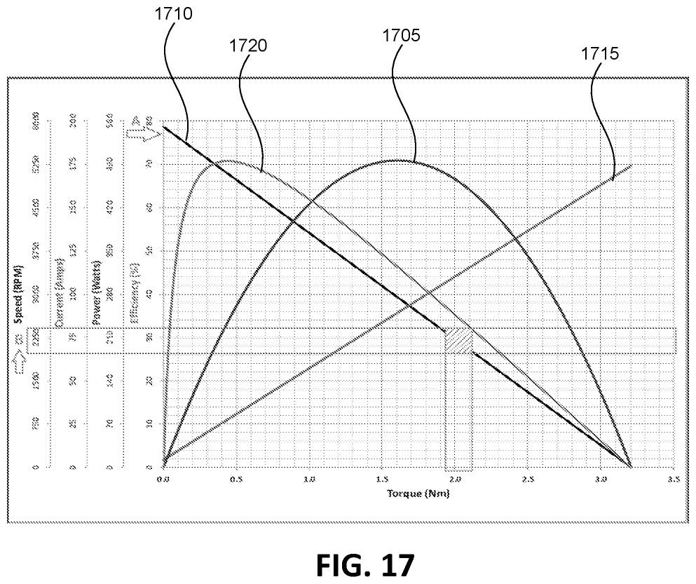

In any of the embodiments herein, a rotational drive motor, drive shaft, and/or blade element may be selected and configured to allow for direct axial alignment of the components for directly driving the blade element at one or more desired rotational speeds. Such direct driving may be achieved in certain implementations without the use of gears or transmissions between the drive motor and the blade element (as shown in appliances 700, 1100). In one such example, such gears and/or transmissions that are omitted are gears that modify the rotational speed. In one such implementation, the rotational drive motor, drive shaft, and blade element are aligned axially along a first axis defined by the axis of the drive shaft. An exemplary rotational drive motor is selected and configured having a given power characteristic (e.g., a power delivery curve such as a curve describing the power (watts) of the motor output in relation to power input, torque output, efficiency, etc.) and a given torque output characteristic, along with other defining output and input characteristics. Selection and configuration of the rotational drive motor (e.g., based on its input/output characteristics), drive shaft (e.g., material, dimensions, etc.), and blade element (e.g., blade count, shape, configuration, edge characteristics, flow characteristics, etc.) can be done such that in operation outside of a frozen food precursor or resultant product, the blade element will be directly driven to a first rotational speed and when the blade element is in contact with precursor or resultant product, the blade element is driven at a second rotational speed. In one example, the second rotational speed is at a speed about 1,000 revolutions per minute (rpm) to about 4,000 rpm. In another example, the second rotational speed is at a speed of about 2,000 rpm to about 3,000 rpm. In another example, the second rotational speed is at a speed of about 2,500 rpm to about 3,500 rpm. In still another example, the second rotational speed is at a speed of about 3,000 rpm. In yet another example, the second rotational speed is at a speed of about 2,000 rpm. In such examples, the first rotational speed may be a speed that is greater than that of the second rotational speed. The desired first rotational speed may be predetermined and set by a manufacturer and/or user of a frozen food appliance (e.g., such that the relationship of the first rotational speed to the second rotational speed is at least based upon one or more of the input/output characteristics of the rotational drive motor, and optionally on the configuration and selection of the drive shaft and blade element characteristics). FIG. 17 illustrates one exemplary chart of performance characteristics (power output 1705, rotational speed 1710, current 1715, and efficiency 1720 each plotted against corresponding torque) of an example rotational drive motor of an example rotational drive apparatus of the current disclosure. The chart illustrates a point “A” at which rotation speed is high, but torque is low. Indicator “B” highlights a range of rotational speed, current, power, and corresponding torque that represents one example of a desired rotational speed for a rotational drive motor.

FIGS. 15A-D show respectively a side view, a top perspective view, a top view, and a bottom perspective view of blade element 702 which includes four blades 1502, 1504, 1506, 1508 each extending from mounting portion 728. Blades 1502 and 1504 are positioned higher on mounting portion 728 than blades 1506 and 1508. Blades 1506 and 1508 are configured with leading edges 1510, 1512 respectively, slanted downward such that when blade element 702 is lowered to an upper surface of a frozen precursor in a container (e.g., container 716) leading edges 1510, 1512 come into contact with the upper surface. Leading edges 1510, 1512 include notches 1514. In one exemplary aspect, notches 1514 may be shaped and configured to assist portions of precursor separated from frozen precursor upper surface to move upwardly as blade element 702 rotates. In another exemplary aspect, notches 1514 may be shaped and configured to reduce the torque of rotation required to rotate blade element 702 in contact with a frozen precursor and/or through separated precursor aerating above the frozen precursor upper surface. Additional features 1516 are provide on a bottom surface of mounting portion 728. Blades 1506, 1508 have trailing edges 1518, 1520 respectively. Blades 1502 and 1504 have leading edges 1522, 1524 respectively and trailing edges 1526, 1528 respectively with a blade shape and configuration similar to that of a wing. Blades 1502 and 1504 are positioned such that their leading edges 1522, 1524 do not come into contact with the upper surface of a frozen precursor as blade element 702 rotates, but rotate above and through separated precursor providing agitation and aeration of the separated precursor. In the example of blade element 702 used with appliance 700 and container 716, the radius of the blades of blade element 702 is such that the blades do not come close to the inner walls of container 716 (i.e., the diameter of blade element 702 is smaller than the diameter of the opening of container 716) as in one or more previous examples in this disclosure. In one exemplary aspect, this size decrease may assist with reducing torque requirements for rotating blade element 702 through precursor material (both frozen precursor surface and separated precursor). A balance between torque efficiency and separation/aeration of precursor may be achieved with a diameter just large enough to ensure that for a particular container size precursor is not left frozen/unseparated/unaerated on the outer portions of the container. A blade element that is similar to blade element 702 may be utilized with any of the embodiments of a frozen food appliance disclosed herein.

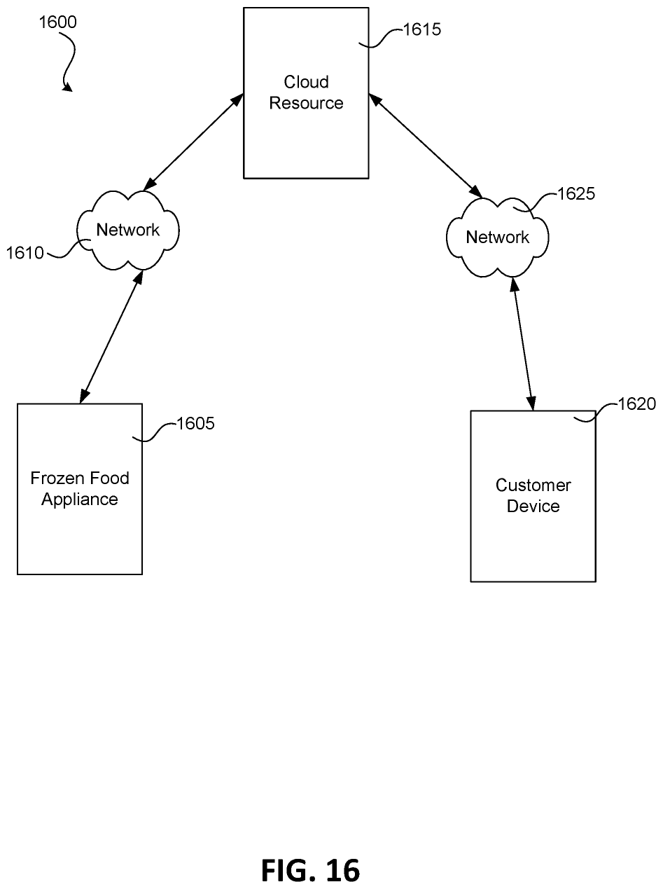

FIG. 10 illustrates an exemplary network environment 1600 for a frozen food appliance (e.g., appliance 200, 400, 600, 700, 1100) for connection to one or more remote devices. In FIG. 16, appliance 1605 is connected to a network 1610. Network 1610 may include any one or more networks. A cloud resource 1615 is connected to network 1610. Cloud resource 1615 is a network connected information source and/or data store for appliance 1605. Cloud resource 1615 may be a resource operated by a manufacturer or seller of appliance 1605 to provide appliance 1605 with one or more functionalities. Cloud resource 1615 may also include one or more publicly accessible information sources. Example functionalities include, but are not limited to, access to information related to a frozen food container (e.g., as referenced by an information associated with a container identifier module), connectivity to an computer executable application with features for operation of an appliance, firmware updates to an appliance, connectivity to a user account (e.g., an account associated with a registered user of the connected appliance), functionality for ordering containers of frozen food precursor, connection to a cloud based artificial intelligence programmed for features related to an appliance, routing and/or app processing related to connecting a user computing device (e.g., via an app) to an appliance, and any combinations thereof. A cloud resource may include one or more computing devices, each having one or more memory devices associated therewith having computer readable instructions thereon that include instructions for performing any one or more of the functionalities.

A customer computing device 1620 is connected to cloud resource 1615 via a network 1625. Network 1625 may include one or more of the same networks of network 1610. Device 1620 may include a display device (e.g., an LCD display device, a touchscreen, etc.). Device 1620 may include machine executable instructions (e.g., stored in a memory) in the form of an app configured to provide a user interface to appliance 1605. The app may include any of the functionalities discussed in the previous paragraph and/or additional functionalities allowing a user to operate the appliance 1605.

It is to be noted that any one or more of the aspects and embodiments described herein may be conveniently implemented using one or more machines (e.g., a computing device, control circuitry of an appliance described herein) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs and/or is stored on a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. A memory device or element may include one or more machine-readable storage media. Examples of a machine-readable storage medium include, but are not limited to, a magnetic disk (e.g., a conventional floppy disk, a hard drive disk), an optical disk (e.g., a compact disk “CD”, such as a readable, writeable, and/or re-writable CD; a digital video disk “DVD”, such as a readable, writeable, and/or rewritable DVD), a magneto-optical disk, a read-only memory “ROM” device, a random access memory “RAM” device, a magnetic card, an optical card, a solid-state memory device (e.g., a flash memory), an EPROM, an EEPROM, and any combinations thereof. Such examples are hardware storage media. A machine-readable medium, as used herein, is intended to include a single medium as well as a collection of physically separate media, such as, for example, a collection of compact disks or one or more hard disk drives in combination with a computer memory. As used herein, a machine-readable storage medium does not include a signal.

The following is a further exemplary implementation of a frozen food appliance for processing a frozen food precursor positioned in a frozen food container into a frozen food product, the frozen food container having an opening, the appliance including: a container mount having a container connector including one or more connector components and/or seals for forming a connection to the opening of a frozen food container; a rotational drive motor having a first torque characteristic and a first power characteristic; a blade element; a rotational drive shaft having a first end and a second end, the first end connected to the rotational drive motor, the second end connected to the blade element, the rotational drive shaft configured to be driven by the rotational drive motor such that the blade element rotates in a circular motion around a first axis formed by the rotational drive shaft, wherein the rotational drive motor, rotational drive shaft, and blade element are positioned in axial alignment with each other to form a rotational drive assembly; and a height adjustment motor connected to the rotational drive assembly, the height adjustment motor configured to move the rotational drive assembly axially along the first axis such that the blade element is movable through the opening of a frozen food container to come into contact with a frozen food precursor positioned in a frozen food container when the frozen food container is connected to the container connector, wherein the rotational drive assembly causes the blade element to rotate at a first rotational speed when the blade element is not in contact with a frozen food precursor, wherein when the frozen food container is connected to the container connector and the blade element is in contact with the frozen food precursor in the frozen food container, the blade element rotates around the first axis at a second rotation speed that is a speed in the range of about 1,000 rpm to about 4,000 rpm, first rotation speed being a predetermined speed that is greater than the second rotation speed wherein the difference between the first rotation speed and the second rotation speed is not achieved using a rotational speed modifying gear or transmission between the rotational drive motor and the blade element.

The exemplary implementation set forth in the prior paragraph may be modified by one or more of the following: wherein the first rotation speed is set by a manufacturer or user of the frozen food appliance and the relationship between the first rotation speed and the second rotation speed is based on the first torque characteristic and the first power characteristic; wherein the second rotation speed is a speed in the range of about 2,000 rpm to about 3,000 rpm; wherein the second rotation speed is a speed in the range of about 2,500 rpm to about 3,500 rpm; wherein the second rotation speed is a speed of about 3,000 rpm; wherein the second rotation speed is a speed of about 2,000 rpm; wherein the container connector includes a component selected from the group consisting of a shroud, a bayonet connector, a snap connector, a screw connector, and any combinations thereof; wherein the container connector includes a locking collar mechanism, the locking collar mechanism including an upper collar shroud and a lower collar shroud, the upper collar shroud being fixedly connected to the container mount, the lower collar shroud is rotatably connected to the upper collar shroud such that as the lower collar shroud is rotated, the lower collar shroud moves downwardly with respect to the frozen food appliance to a position that allows contact with a frozen food container; wherein the container connector includes one or more components and/or seals configured to provide an air seal between an inside portion of the frozen food container that is above a frozen food precursor and the outside of the frozen food container when the frozen food container is connected to the container connector; wherein the container connector includes one or more components and/or seals configured to provide an air seal between an inside portion of the frozen food container that is above a frozen food precursor and the outside of the frozen food container when the frozen food container is connected to the container connector and further comprising a gas pump connected to the container connector to provide a gas to the inside portion; wherein the container mount includes a first shaft opening through which the rotational drive shaft passes and the container mount is connected to the rotational drive assembly such that a frozen food container when connected to the container mount remains in substantial axial alignment with the rotational drive shaft if the first axis changes position; wherein the container mount includes a first portion including the container and a second portion connected to the frozen food appliance via a housing and/or support structure, the first portion including a shaft opening through which the rotational drive shaft is positioned, the first portion and second portion connected via a float connector having a first range of motion between the first portion and the second portion, the first portion connected to the rotational drive assembly wherein if the position of the first axis changes longitudinally with respect to the housing and/or support structure, the first portion changes its position with respect to the second portion through the first range of motion and remains in substantial axial alignment with the first axis; wherein the container mount includes a floating connector dividing a first portion of the container mount from a second portion of the container mount and allowing the first portion to move in a lateral direction with respect to the first axis; and any appropriate combinations thereof. Further, the exemplary implementation may have any of its components, features, aspects, and/or functionalities modified by one or more corresponding details described herein with respect to other exemplary implementations (e.g., appliance 200, 400, 600, 700, and/or 1100).

The following is a still further exemplary implementation of a frozen food appliance for processing a frozen food precursor positioned in a frozen food container into a frozen food product, the frozen food container having an opening, the appliance comprising: a rotational drive motor; a blade element; a rotational drive shaft having a first end and a second end, the first end connected to the rotational drive motor, the second end connected to the blade element, the rotational drive shaft configured to be driven by the rotational drive motor such that the blade element rotates in a circular motion around a first axis formed by the rotational drive shaft, wherein the rotational drive motor, rotational drive shaft, and blade element are positioned in axial alignment with each other to form a rotational drive assembly; and a container mount having a first portion including a container connector including one or more connector components and/or seals for forming a connection to the opening of a frozen food container and a second portion connected to the frozen food appliance via a housing and/or support structure, the first portion including a shaft opening through which the rotational drive shaft is positioned, the first portion and second portion connected via a float connector having a first range of motion between the first portion and the second portion, the first portion connected to the rotational drive assembly wherein if the position of the first axis changes longitudinally with respect to the housing and/or support structure, the first portion changes its position with respect to the second portion through the first range of motion and remains in substantial axial alignment with the first axis.

The exemplary implementation set forth in the prior paragraph may be modified by one or more of the following: further comprising a height adjustment motor connected to the rotational drive assembly, the height adjustment motor configured to move the rotational drive assembly axially along the first axis such that the blade element is movable through the opening of a frozen food container to come into contact with a frozen food precursor positioned in a frozen food container when the frozen food container is connected to the container connector. wherein the rotational drive assembly causes the blade element to rotate at a first rotational speed when the blade element is not in contact with a frozen food precursor, wherein when the frozen food container is connected to the container connector and the blade element is in contact with the frozen food precursor in the frozen food container, the blade element rotates around the first axis at a second rotation speed that is a speed (the speed being in the range of about 1,000 rpm to about 4,000 rpm, in the range of about 2,000 rpm to about 3,000 rpm, in the range of about 2,500 rpm to about 3,500 rpm, about 3,000 rpm, or about 2,000 rpm), first rotation speed being a predetermined speed that is greater than the second rotation speed wherein the difference between the first rotation speed and the second rotation speed is not achieved using a rotational speed modifying gear or transmission between the rotational drive motor and the blade element; wherein the container connector includes a component selected from the group consisting of a shroud, a bayonet connector, a snap connector, a screw connector, and any combinations thereof; wherein the container connector includes a locking collar mechanism, the locking collar mechanism including an upper collar shroud and a lower collar shroud, the upper collar shroud being fixedly connected to the container mount, the lower collar shroud is rotatably connected to the upper collar shroud such that as the lower collar shroud is rotated, the lower collar shroud moves downwardly with respect to the frozen food appliance to a position that allows contact with a frozen food container; wherein the container connector includes one or more components and/or seals configured to provide an air seal between an inside portion of the frozen food container that is above a frozen food precursor and the outside of the frozen food container when the frozen food container is connected to the container connector; wherein the container connector includes one or more components and/or seals configured to provide an air seal between an inside portion of the frozen food container that is above a frozen food precursor and the outside of the frozen food container when the frozen food container is connected to the container connector and further comprising a gas pump connected to the container connector to provide a gas to the inside portion; wherein the rotational drive assembly delivers a rotational motion to the blade element without a rotational speed modifying gear or transmission positioned between the rotational drive motor and the blade element; and any appropriate combinations thereof. Further, the exemplary implementation may have any of its components, features, aspects, and/or functionalities modified by one or more corresponding details described herein with respect to other exemplary implementations (e.g., appliance 200, 400, 600, 700, and/or 1100).

Methods of producing a frozen food product include methods of using the implementations and embodiments set of a frozen food appliance described herein as each component, feature, and functionality is described, either alone or in combination with other components, features, and functionalities described. The following is one example of a method of producing a frozen food product including causing a rotational drive apparatus of a frozen food appliance to rotate a blade element at a first rotational speed, the rotational drive apparatus including an axially aligned rotational motor and drive shaft that directly drive the blade element without the use of a speed modifying gear or transmission between the rotational motor and the blade element, bringing the blade element into contact with a frozen food precursor in a frozen food container such that the blade element rotates at a second rotational speed that is slower than the first rotational speed and is a speed in a range of about 1,000 rpm to about 4,000 rpm, first rotation speed being a predetermined speed that is greater than the second rotation speed wherein the difference between the first rotation speed; and continuing to rotate the blade element at the second rotational speed through at least a portion of the frozen food precursor to for a frozen food product. Further, this exemplary implementation of a method may have any of its steps, substeps, functionalities, components, features, aspects, and/or elements modified by one or more corresponding details described herein with respect to other exemplary implementations (e.g., appliance 200, 400, 600, 700, and/or 1100).

In general, the systems, methods, etc. of the present invention have been exemplified by various exemplary embodiments and implementations as shown in the accompanying drawings and as described above. However, it should be understood that the presentation of these embodiments and implementations should not be construed as requiring that: 1) these embodiments and implementations stand in isolation from one another; 2) that individual components, features, aspects, and/or functionalities described relative to each one of the embodiments and implementations cannot be used independently of the corresponding embodiment or implementation; and 3) that individual components, features, aspects, and/or functionalities described cannot be used individually in connection with other embodiments and implementations, either described herein or derivable therefrom, alone and/or in any combination with one another. On the contrary, those skilled in the art will appreciate that the individual components, features, aspects, and functionalities of a particular embodiment or implementation can, as appropriate under the circumstances, be utilized alone and in any subcombination with other components, features, aspects, and/or functionalities of that particular embodiment or implementation and with any other embodiment or implementation, including the specific examples described herein. It is also noted that where numerical values are included herein either as singular or range values with the term “about”, the same numerical values are contemplated in additional examples and implementations without the term “about” as a modifier to the numerical value.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. A frozen food appliance for processing a frozen food precursor positioned in a frozen food container into a frozen food product, the frozen food container having an opening, the appliance comprising:
a container mount having a container connector including one or more connector components and/or seals for forming a connection to the opening of a frozen food container, wherein the container connector includes a locking collar mechanism, the locking collar mechanism including an upper collar shroud and a lower collar shroud, the upper collar shroud being fixedly connected to the container mount, the lower collar shroud is rotated, the lower collar shroud moves downwardly with respect to the frozen food appliance to a position that allows contact with a frozen food container;
a rotational drive motor having a first torque characteristic and a first power characteristic;
a blade element;
a rotational drive shaft having a first end and a second end, the first end connected to the rotational drive motor, the second end connected to the blade element, the rotational drive shaft configured to be driven by the rotational drive motor such that the blade element rotates in a circular motion around a first axis formed by the rotational drive shaft, wherein the rotational drive motor, rotational drive shaft, and blade element are positioned in axial alignment with each other to form a rotational drive assembly; and
a height adjustment motor connected to the rotational drive assembly, the height adjustment motor configured to move the rotational drive assembly axially along the first axis such that the blade element is movable through the opening of a frozen food container to come into contact with a frozen food precursor positioned in a frozen food container when the frozen food container is connected to the container connector, wherein the rotational drive assembly causes the blade element to rotate at a first rotational speed when the blade element is not in contact with a frozen food precursor, wherein when the frozen food container is connected to the container connector and the blade element is in contact with the frozen food precursor in the frozen food container, the blade element rotates around the first axis at a second rotation speed that is a speed in the range of about 1,000 rpm to about 4,000 rpm, first rotation speed being a predetermined speed that is greater than the second rotation speed wherein the difference between the first rotation speed and the second rotation speed is not achieved using a rotational speed modifying gear or transmission between the rotational drive motor and the blade element.

2. A frozen food appliance according to claim 1, wherein the first rotation speed is set by a manufacturer or user of the frozen food appliance and the relationship between the first rotation speed and the second rotation speed is based on the first torque characteristic and the first power characteristic.

3. A frozen food appliance according to claim 1, wherein the second rotation speed is a speed in the range of about 2,000 rpm to about 3,000 rpm.

4. A frozen food appliance according to claim 1, wherein the second rotation speed is a speed in the range of about 2,500 rpm to about 3,500 rpm.

5. A frozen food appliance according to claim 1, wherein the second rotation speed is a speed of about 3,000 rpm.

6. A frozen food appliance according claim 1, wherein the second rotation speed is a speed of about 2,000 rpm.

7. A frozen food appliance according to claim 1, wherein the container connector includes a component selected from the group consisting of a shroud, a bayonet connector, a snap connector, a screw connector, and any combinations thereof.

8. (canceled)

9. A frozen food appliance according to claim 1, wherein the container connector includes one or more components and/or seals configured to provide an air seal between an inside portion of the frozen food container that is above a frozen food precursor and the outside of the frozen food container when the frozen food container is connected to the container connector.

10. A frozen food appliance according to claim 9, further comprising a gas pump connected to the container connector to provide a gas to the inside portion.

11. A frozen food appliance according to claim 1, wherein the container mount includes a first shaft opening through which the rotational drive shaft passes and the container mount is connected to the rotational drive assembly such that a frozen food container when connected to the container mount remains in substantial axial alignment with the rotational drive shaft if the first axis changes position.

12. A frozen food appliance according to claim 1, wherein the container mount includes a first portion including the container and a second portion connected to the frozen food appliance via a housing and/or support structure, the first portion including a shaft opening through which the rotational drive shaft is positioned, the first portion and second portion connected via a float connector having a first range of motion between the first portion and the second portion, the first portion connected to the rotational drive assembly wherein if the position of the first axis changes longitudinally with respect to the housing and/or support structure, the first portion changes its position with respect to the second portion through the first range of motion and remains in substantial axial alignment with the first axis.

13. A frozen food appliance according to claim 1, wherein the container mount includes a floating connector dividing a first portion of the container mount from a second portion of the container mount and allowing the first portion to move in a lateral direction with respect to the first axis.

14.-26. (canceled)
